(19) United States
(12) Patent Application Publication
(10) Pub. No.: US 2020/0130892 A1
(43) Pub. Date: Apr. 30, 2020

(54) CONTAINER PRECURSOR HAVING A WALL OF GLASS WHICH IS SUPERIMPOSED BY A PLURALITY OF PARTICLES

(71) Applicant: SCHOTT AG, Mainz (DE)

(72) Inventors: Stephanie Mangold, Klein-Winternheim (DE); Frank Heinricht, Flein (DE); Eveline Rudigier-Voigt, Mainz (DE); Andrea Anton, Hüffelsheim (DE)

(73) Assignee: SCHOTT AG, Mainz (DE)

(21) Appl. No.: 16/668,016

(22) Filed: Oct. 30, 2019

(30) Foreign Application Priority Data
Oct. 30, 2018 (EU) 18203496.7

(51) Int. Cl. B65D 23/08; B65D 25/14

(52) U.S. Cl. CPC B65D 23/0814; A61J 1/065; B65D 25/14

(57) ABSTRACT

Container precursors are provided that have a wall of glass. The wall of glass at least partially encloses an interior volume. The wall of glass has a side that faces away from the interior volume. The side is at least partially superimposed by a plurality of particles. An arrangement is also provided that includes a packaging and a multitude of the container precursors. A process for preparing a functionalised container precursor is also provided. A process for packaging pharmaceutical compositions and closed containers obtainable by this process are provided.

### CROSS REFERENCE TO RELATED APPLICATIONS

This application claims benefit under 35 USC § 119 of European Application 18203496.7 filed Oct. 30, 2018, the entire contents of which are incorporated herein by reference.

### BACKGROUND

### 1. Field of the Invention

The present invention refers to a container precursor having a wall of glass which at least partially encloses an interior volume; wherein, on a side of the wall of glass which faces away from the interior volume, the wall of glass is at least partially superimposed by a plurality of particles.

### 2. Description of Related Art

Containers made from glass have been applied for transporting fluids and powders safely since several centuries. In the last decades, the arts in which glass containers are used for transporting fluids and powders have become increasingly diverse and sophisticated. One such art is the technical field of the present application: pharmaceutical packaging. In the pharmaceutical industry, glass containers—such as vials, syringes, ampoules and cartridges—are applied as primary packaging for all kinds of pharmaceutically relevant compositions, in particular drugs, such as vaccines. Specifically in this art, the requirements put on the glass containers have become more and more sophisticated, recently.

The pharmaceutical glass containers are, typically, cleaned, sterilised, filled and closed, on an industrial scale in a line of processing, referred to as filling line in this document. There is a need to increase a production rate of such a filling line in the art. This may be implemented by increasing a velocity of the filling line and/or by reducing shut down times due to disruptions of the processing.

In the prior art, such disruptions are may be caused by the occurrence of breakage of glass containers during processing, in particular due to high transportation velocities on the filling line. If such breakage occurs, production has to be stopped, the line has to be cleaned thoroughly from particles and dust and then the system has to be readjusted before it is started again. Contamination of the glass containers with any kind of pharmaceutically relevant particles, in particular glass particles, or pharmaceutically relevant substances has to be avoided strictly, in particular if parenteralia are packaged.

Further, scratches on the glass surfaces of the containers have to be avoided as far as possible. Scratches on the container surface may hamper an optical inspection of the filled containers, in particular for the presence of pharmaceutically relevant particles. Further, scratching the containers can lead to glass particles or dust being disassociated from the containers. These particles and dust may contaminate the containers on the filling line.

In general, attempts to solve the above problems by applying a coating to the container surface are known in the prior art. The requirements on such coatings are rather sophisticated. They have to withstand high temperatures which occur in a treatment referred to in the art as depyrogenisation. Further, the coatings have to withstand low temperature treatments such as freeze drying. Even more, the coatings have to withstand washing processes, which include increased temperatures and mechanical influences. This means that the advantageous properties which the coating provides to the exterior surface of the container have to be maintained and, in addition, contamination of the container interior with any pharmaceutically relevant particle or substance from the coating has to be avoided. The preceding sophisticated requirements have led to the development of rather complex multilayer coatings of the prior art. Such multilayer coatings are typically complex and costly to apply and thus, run contrary to the need for high processing rates.

Further, the coatings of the prior art are often applied to the glass containers across their whole exterior surface, including the container bottom. While these coatings, however, provide advantageous effects in certain regions of the exterior surface of the containers, it has been determined by the present disclosure that their presence in other regions, such as the container bottom, is disadvantageous. For example, it has been determined by the present disclosure that decreasing the static friction of the container bottom causes disadvantageous behaviour of the containers on a filling line.

In particular, it has been determined by the present disclosure that containers having bottoms with too low static friction tend to accelerate each other on the filling line which can lead to containers being scratched as they bump into each other or even to containers tilting over and/or falling from the filling line.

Moreover, glass containers for pharmaceutical packaging are often produced from container precursors which have been prepared beforehand. Applying coatings to the containers cannot prevent scratches which stem from handling the container precursors prior to the containers even being formed from the precursors. For the preparation of a container precursor, typically, a semi-endless tubular strand is drawn from a glass melt. This semi-endless strand is cut into multiple shorter tubes, the ends of which are sealed by hot forming the glass. The sealed tubes obtained this way are usually packaged and transported to the manufacturer of the pharmaceutical packaging containers. Accordingly, there is a risk that the glass tubes suffer from scratches and other defects during packaging, shipping and corresponding handling prior to containers being manufactured from the tubes. Production of the glass containers typically involves cutting off and discarding the sealed ends of the tubes and hot forming multiple containers from each open tube. Pharmaceutical glass containers such as vials, syringes, ampoules and cartridges have tubular body regions which have already been present in the corresponding tube from which the container has been prepared. If a tube includes a defect such as a scratch in a region which later on will constitute the tubular body region of a container, the defect will show up in the container made from the tube as well. Therefore, defects in the precursor tubes have to be avoided and thus, the precursor tubes have to be protected as well. In the prior art, this is typically done by applying a temporary organic coating to the tubes. This organic coating is burned off in the process of container production, e.g. in the leer. Hence, in order to avoid scratches, in the prior art, first the precursor tubes are coated and later on a different coating is applied to the glass containers made from the tubes. This solution of the prior art is laborious and cumbersome.

### SUMMARY

In general, it is an object of the present invention to at least partly overcome a disadvantage arising from the prior art.

It is a further object of the invention to provide a precursor for the production of a glass container for pharmaceutical packaging which allows for an increase of a production rate of a filling line.

Further, it is an object of the present invention to provide a precursor for the production of a glass container for pharmaceutical packaging which allows for an increase of a processing speed of a filling line, or for a reduction of disruptions of a filling line, or both.

It is yet another object of the invention to provide a precursor from which a glass container for pharmaceutical packaging that is less prone to show scratches can be produced.

Further, it is an object of the invention to provide a precursor from which a glass container for pharmaceutical packaging that is less prone to being damaged or even broken while being processed on a filling line can be produced.

According to another object of the invention, one of the above advantageous precursors is provided, wherein a glass container for pharmaceutical packaging formed from the precursor is further suitable for an easy and reliable optical inspection after having been filled.

According to yet another object of the invention, one of the above advantageous precursors is provided, wherein a glass container for pharmaceutical packaging formed from the precursor is further suitable for a post-treatment, for example a sterilisation treatment, which may be effected as a high-temperature-treatment—in particular a depyrogenisation; or a washing process; or a low-temperature-treatment—in particular a freeze drying.

According to yet another object of the invention, one of the above advantageous precursors is provided, wherein a glass container for pharmaceutical packaging formed from the precursor does not show an increased tendency to being contaminated in a pharmaceutically relevant manner, preferably the container shows a reduced tendency to being contaminated. The preceding contamination refers, in particular, to the presence of pharmaceutically relevant particles or substances, such as organic substances, in the container interior.

According to yet another object of the invention, a glass container for pharmaceutical packaging which is less prone to have pre-damages is provided. Herein, pre-damages refer to damages which the container inherits from a precursor from which the container is prepared.

According to a further object of the invention, the preceding container, additionally, shows one or more of the advantages mentioned above.

According to a further object of the invention, the preceding container can be prepared by an as simple as possible process. According to yet another object of the invention, a glass container for pharmaceutical packaging formed from one of the above advantageous precursors is provided.

According to another object of the invention, the preceding advantageous container is provided, wherein the container does not have a multilayer coating on a surface, preferably the exterior surface, of the glass container. In particular, no primer layer is needed here. According to yet another object of the invention, an advantageous combination of a multitude of precursors for the production of a glass container for pharmaceutical packaging and a packaging for these precursors is provided, wherein this combination allows for producing containers with as few as possible pre-damages. Therein, the process for producing the containers is, according to another object, as simple as possible, in particular in terms of a number of process steps.

### BRIEF DESCRIPTION OF THE DRAWINGS

Unless otherwise specified in the description or the particular figure:

FIG. 1 shows a schematic depiction of a container precursor according to the invention;

FIG. 2 shows a schematic depiction of an arrangement according to the invention;

FIG. 3 shows a schematic depiction of another arrangement according to the invention;

FIG. 4 shows a flow chart of a process according to the invention for preparing a functionalised container precursor;

FIG. 5 shows a schematic depiction of a container according to the invention;

FIG. 6 shows a flow chart of a process for preparing a functionalised container;

FIG. 7 shows a schematic depiction of a closed container according to the invention;

FIG. 8 shows a flow chart of a process according to the invention for packaging a pharmaceutical composition;

FIG. 9 shows a flow chart of a process according to the invention for treating a patient;

FIG. 10 shows a diagram with results of measurements of the coefficient of dry sliding friction of vials of example 1 and comparative example 4;

FIG. 11 shows results of measurements of the transmission coefficient of vials according to the examples 1 to 5 and the comparative example 4;

FIG. 12 shows a microscope image of the exterior surface of a functionalised container precursor according to example 1;

FIG. 13 shows a further microscope image of the exterior surface of the functionalised container precursor according to example 1;

FIG. 14 shows a microscope image of the exterior surface of a vial according to example 2 prior to freeze drying; and

FIG. 15 shows a microscope image of the exterior surface of the vial of FIG. 14 after freeze drying.

### DETAILED DESCRIPTION

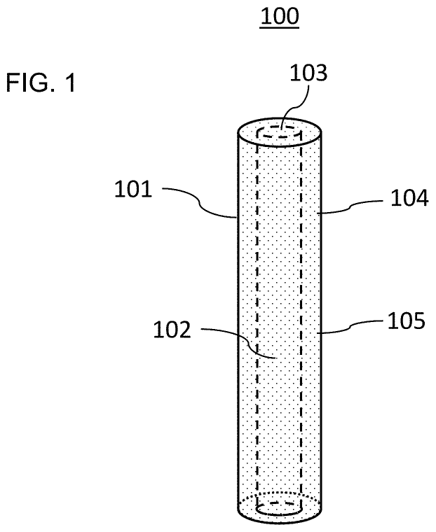

FIG. 1 shows a schematic depiction of a container precursor 100 according to the invention.

The container precursor 100 comprises a wall of glass 101 which fully encloses an interior volume 102 of the container precursor 100. The wall of glass 101 forms a hollow glass body 104. The hollow glass body 104 consists of a tube, which is a right circular cylinder, and two end face parts 103 which each seal an end face of the tube. On a side of the wall of glass 101 which faces away from the interior volume 102, a plurality of particles 1201 adjoins the wall of glass 101 across its full surface area. Further, the hollow glass body 104 has a precursor exterior surface 105 which faces away from the interior volume 102 and which is formed from the wall of glass 101 and the plurality of particles 1201. The precursor exterior surface 105 is characterised by a coefficient of dry sliding friction of 0.01 and a contact angle for wetting with water of 30°, in each case across its full surface area. The container precursor 100 of FIG. 1 is a precursor which has been obtained in accordance with example 1 according to the invention as explained above. Accordingly, the particles 1201 are SiO₂-particles which have been obtained from the polysilsesquioxane-particles which have been applied to the wall of glass 101.

A contribution to solving at least one of the objects according to the invention is made by an embodiment 1 of a container precursor 1, comprising a wall of glass which at least partially, encloses an interior volume of the container precursor; wherein, on a side of the wall of glass which faces away from the interior volume, the wall of glass is at least partially superimposed by a plurality of particles. Preferably, the wall of glass forms a hollow glass body which at least partially encloses the interior volume of the container precursor; wherein the hollow glass body has a precursor exterior surface which faces away from the interior volume; wherein the precursor exterior surface is at least partially characterised by a coefficient of dry sliding friction of less than 0.25, preferably less than 0.20, more preferably less than 0.18, more preferably less than 0.16, more preferably less than 0.15, more preferably less than 0.12, more preferably less than 0.10, more preferably less than 0.05, more preferably less than 0.03, most preferably less than 0.02. In a preferred embodiment, the particles of the plurality of particles are directly joined to the wall of glass via Van-der-Waals forces, but not via covalent bonds. In a preferred embodiment, the wall of glass is not superimposed by the plurality of particles on a side of the wall of glass which faces the interior volume. Hence, it is preferred that no particle of the plurality of particles superimposes the wall of glass on a side which faces the interior volume. Preferably, the plurality of particles superimposes the wall of glass on an area which is at least 10%, preferably at least 20%, more preferably at least 30%, more preferably at least 40%, more preferably at least 50%, more preferably at least 60%, more preferably at least 70%, more preferably at least 80%, even more preferably at least 90%, in each case of a total surface area of the wall of glass which faces away from the interior volume, most preferably across the full surface area of the wall of glass which face away from the interior volume.

In an embodiment 2 of the container precursor 1 according to the invention, the container precursor 1 is designed according to its embodiment 1, wherein the plurality of particles is characterised by particle size distribution having a D₅₀ in a range from 1 to 100 μm, preferably from 1 to 80 μm, more preferably from 1 to 60 μm, more preferably from 1 to 40 μm, more preferably from 1 to 20 μm, more preferably from 1 to 15 μm, even more preferably from 2 to 10 μm, most preferably from 2 to 6 μm. In a preferred embodiment, the D₅₀ of the particle size distribution is in a range from 2 to 100 μm, preferably from 2 to 80 μm, more preferably from 2 to 60 μm, more preferably from 2 to 40 μm, more preferably from 2 to 20 μm, more preferably from 2 to 15 μm, even more preferably from 2 to 10 μm, most preferably from 2 to 6 μm. In a preferred embodiment, the particle size distribution of the plurality of particles, additionally, has a D₁₀ in a range from 0.1 to 50 μm, preferably from 0.5 to 10 μm, more preferably from 0.5 to 5 μm, most preferably from 1 to 3 μm; or a D₉₀ in a range from 0.5 to 100 μm, preferably from 0.5 to 50 μm, more preferably from 1 to 20 μm, most preferably from 2 to 10 μm; or both. Preferably, the plurality of particles forms at least a part of a surface of the container precursor which faces away from the interior volume.

In an embodiment 3 of the container precursor 1 according to the invention, the container precursor 1 is designed according to its embodiment 1 or 2, wherein the particles of the plurality of particles at least partially have a decomposition temperature of more than 500° C., preferably more than 600° C., more preferably more than 700° C., more preferably more than 800° C., more preferably more than 900° C., more preferably more than 1,000° C., more preferably more than 1,100° C., more preferably more than 1,200° C., more preferably more than 1,300° C., most preferably more than 1,400° C. Preferably, the decomposition temperature of the particles of the plurality of particles is not more than 2,000° C., more preferably not more than 1,900° C., most preferably not more than 1,800° C. Here, the particles of the plurality of particles may, in addition to a part which has the preceding decomposition temperature, include parts which have decomposition temperatures that are below the preceding lower decomposition temperature limit. The latter parts may, for example, be organic. Organic parts, preferably, include one or more of the substances disclosed herein in the context of organic particles. In consequence, in the decomposition test described below in the measurement methods section, such particles may shrink. Preferably, the particles of the plurality of particles do not include any part which has a decomposition temperature above the preceding upper limit.

In an embodiment 4 of the container precursor 1 according to the invention, the container precursor 1 is designed according to any of its preceding embodiments, wherein the particles of the plurality of particles are selected from the group consisting of organic particles, inorganic particles, and hybrid polymer particles, or a combination of at least two thereof. Here, a combination of at least two of the preceding types of particles refers to a plurality of particles which comprises particles of at least two different types from the preceding list. Further, the particles of the plurality of particles are particularly preferred organic particles, or hybrid polymer particles, or both.

In an embodiment 5 of the container precursor 1 according to the invention, the container precursor 1 is designed according to its embodiment 4, wherein the inorganic particles comprise, preferably consist of, one selected from the group consisting of a boron nitride, a molybdenum sulphide, a silicon nitride, an oxide, and a compound which includes covalently bonded H, or a combination of at least two thereof. A preferred molybdenum sulphide is MoS₂. A preferred silicon nitride is Si₃N₄. A preferred oxide is a silicon oxide or a titanium oxide or both. A preferred silicon oxide is SiO₂. A preferred titanium oxide is TiO₂. A preferred inorganic compound which includes covalently bonded H is a siloxane, or a silane, or both.

In an embodiment 6 of the container precursor 1 according to the invention, the container precursor 1 is designed according to its embodiment 4 or 5, wherein the organic particles comprise, preferably consist of, a compound which includes covalently bonded H. A preferred organic compound which includes covalently bonded H is a polymer of one or more siloxanes, or an organo-silane, or both. Additionally or alternatively preferred, organic particles which comprise a compound which includes covalently bonded H comprise this compound as part of a latex, or of a silicone resin, or both.

In an embodiment 7 of the container precursor 1 according to the invention, the container precursor 1 is designed according to any of its embodiments 4 to 6, wherein the hybrid polymer particles comprise, preferably consist of, a compound which includes covalently bonded H. A preferred hybridpolymer compound which includes covalently bonded H is a hybridpolymer silane, or a hybridpolymer siloxane, or both. A preferred hybridpolymer siloxane is a polyorganosiloxane, more preferably a polyalkylsiloxane or a polysilsesquioxane or both.

In an embodiment 8 of the container precursor 1 according to the invention, the container precursor 1 is designed according to any of its preceding embodiments, wherein the particles of the plurality of particles comprise, preferably consist of, a compound which includes covalently bonded H. A preferred compound including covalently bonded H is a silane, or a siloxane, or both. A preferred silane is an inorganic silane, or a hybridpolymer silane, wherein a hybridpolymer silane is particularly preferred. A preferred siloxane is one selected from the group consisting of an inorganic siloxane, a polymer of one or more siloxanes, an organo-silane, and a hybridpolymer siloxane or both, wherein a hybridpolymer siloxane is particularly preferred. Additionally or alternatively preferred, particles which comprise a compound which includes covalently bonded H comprise this compound as part of a latex, or of a silicone resin, or both.

In an embodiment 9 of the container precursor 1 according to the invention, the container precursor 1 is designed according to any of its preceding embodiments, wherein the particles of the plurality of particles adjoin the wall of glass. Preferably, the particles of the plurality of particles are directly joined to the wall of glass via Van-der-Waals forces, or via covalent bonds, or both. Here, preferred covalent bonds are Si—O-bonds. In a preferred Si—O-bond, the Si is bonded via one O, or via two O to the wall of glass. In a preferred embodiment, the particles of the plurality of particles are directly joined to the wall of glass via Van-der-Waals forces, but not via covalent bonds.

In an embodiment 10 of the container precursor 1 according to the invention, the container precursor 1 is designed according to any of its preceding embodiments, wherein the particles of the plurality of particles are not superimposed by any component of the container precursor on a side of the particles of the plurality of particles which faces away from the wall of glass. Particularly preferable, the particles of the plurality of particles are not embedded in any material, such as a matrix, for example a polymer matrix. Preferably, the plurality of particles adjoins an environment of the container precursor.

In an embodiment 11 of the container precursor 1 according to the invention, the container precursor 1 is designed according to any of its preceding embodiments, wherein the plurality of particles superimposes the wall of glass at a surface cover ratio in a range from 1 to 50%, preferably from 5 to 40%, more preferably from 5 to 35%, more preferably from 10 to 30%, most preferably from 10 to 25%, in each case based on a surface area of a region of the wall of glass which is superimposed by the plurality of particles. By choosing the surface cover ratio in the preceding ranges contact of the walls of glass of two container precursors of the invention which are contacted with one another in regions in which their walls of glass are superimposed by respective pluralities of particles at the surface cover ratio can substantially be avoided. Hence, the surface cover ratio is high enough that the container precursors contact each other substantially via the particles, not via the substrate surfaces. Further preferably, the surface cover ratio in the preceding ranges is low enough to substantially avoid deterioration of the optical properties of the container precursor, such as its transmission coefficient and haze in accordance with the measurement methods described herein.

In an embodiment 12 of the container precursor 1 according to the invention, the container precursor 1 is designed according to any of its preceding embodiments, wherein the particle size distribution has a full width at half maximum (FWHM) which is less than 30%, preferably less than 25%, more preferably less than 20%, even more preferably less than 15%, most preferably less than 10%, in each case of the D₅₀ of the particle size distribution. The preceding FWHM values help to prevent the container precursor from being scratched upon contact to another container precursor, for example during transport, by distributing the contact force across a sufficiently large amount of particles, thereby limiting the pressure which acts on the container precursors. Further, a gliding friction is reduced which can mitigate the risk of damages to the container precursors.

In an embodiment 13 of the container precursor 1 according to the invention, the container precursor 1 is designed according to any of its preceding embodiments, wherein the particles of the plurality of particles are characterised by an aspect ratio in a range from 0.5 to 1.5, preferably from 0.6 to 1.4, more preferably from 0.7 to 1.3, more preferably from 0.8 to 1.2, most preferably from 0.9 to 1.1. Particularly preferable, the particles of the plurality of particles are spherical. An aspect ratio in the preceding ranges allows the particles to exert a rolling motion upon contact of two container precursors with one another. This, in particular, helps to mitigate scratches and gliding friction which can lead to damages to the container precursors.

In an embodiment 14 of the container precursor 1 according to the invention, the container precursor 1 is designed according to any of its preceding embodiments, wherein, on a side of the wall of glass which faces away from the interior volume, the wall of glass is at least partially characterised by a contact angle for wetting with water in a range from 0 to 45°, preferably from 5 to 45°, more preferably 10 to 45°.

A contribution to solving at least one of the objects according to the invention is made by an embodiment 1 of a container precursor 2, comprising a wall of glass which forms a hollow glass body which at least partially encloses an interior volume of the container precursor; wherein the hollow glass body has a precursor exterior surface which faces away from the interior volume; wherein the precursor exterior surface is at least partially characterised by a coefficient of dry sliding friction of less than 0.25, preferably less than 0.20, more preferably less than 0.18, more preferably less than 0.16, more preferably less than 0.15, more preferably less than 0.12, more preferably less than 0.10, more preferably less than 0.05, more preferably less than 0.03, most preferably less than 0.02.

In an embodiment 2 of the container precursor 2 according to the invention, the container precursor 2 is designed according to its embodiment 1, wherein the precursor exterior surface is further at least partially characterised by a contact angle for wetting with water in a range from 0 to 45°, preferably from 5 to 45°, more preferably 10 to 45°.

In an embodiment 15 of the container precursor 1 according to the invention, the container precursor 1 is designed according to any of its preceding embodiments, and in an embodiment 3 of the container precursor 2 according to the invention, the container precursor 2 is designed according to any of its preceding embodiments, wherein in each case at least one container is obtainable from the container precursor by partially reshaping the wall of glass. Preferably, the at least one container is obtainable from the container precursor by the process 2 of the invention for preparing a functionalised container. Preferably, the container precursor 1 or 2 is a precursor of the container 1 or 2 or both according to the invention.

In an embodiment 16 of the container precursor 1 according to the invention, the container precursor 1 is designed according to any of its preceding embodiments, and in an embodiment 4 of the container precursor 2 according to the invention, the container precursor 2 is designed according to any of its preceding embodiments, wherein in each case the container precursor has a length in a range from 0.1 to 10 m, preferably in a range from 0.1 to 5 m, more preferably from 0.5 to 3 m, most preferably from 1 to 2 m.

In an embodiment 17 of the container precursor 1 according to the invention, the container precursor 1 is designed according to any of its preceding embodiments, and in an embodiment 5 of the container precursor 2 according to the invention, the container precursor 2 is designed according to any of its preceding embodiments, wherein in each case the container precursor has an outer diameter in a range from 5 to 55 mm, preferably in a range from 6 to 50 mm, more preferably from 10 to 42 mm. A particularly preferred container precursor has an outer diameter of 16 mm or 30 mm.

In an embodiment 18 of the container precursor 1 according to the invention, the container precursor 1 is designed according to any of its preceding embodiments, and in an embodiment 6 of the container precursor 2 according to the invention, the container precursor 2 is designed according to any of its preceding embodiments, wherein in each case the container precursor has an inner diameter in a range from 4 to 50 mm, preferably in a range from 8 to 38 mm, more preferably from 10 to 30 mm. A particularly preferred container precursor has an inner diameter of 14 mm or 27 mm.

In an embodiment 19 of the container precursor 1 according to the invention, the container precursor 1 is designed according to any of its preceding embodiments, and in an embodiment 7 of the container precursor 2 according to the invention, the container precursor 2 is designed according to any of its preceding embodiments, wherein in each case the container precursor comprises a tube, wherein the wall of glass constitutes at least a wall of the tube. The container precursor, further to comprising the tube, preferably, includes a first end face part which seals the tube at a first end and, more preferably, also a further end face part which seals the tube at a further end which is opposite the first end. Further preferably, the wall of glass also constitutes the first end face part or the further end face part or both.

In an embodiment 20 of the container precursor 1 according to the invention, the container precursor 1 is designed according to its embodiment 19, wherein in each case the wall of glass is at least partially superimposed by the plurality of particles at a lateral surface of the tube. Further, the tube may also be superimposed by the plurality of particles at a first end face, or at a further end face which is opposite the first end face, or both. In case the first or further end face of the tube is sealed by a first or further end face part, the respective end face part may be superimposed by the plurality of particles as well.

In an embodiment 8 of the container precursor 2 according to the invention, the container precursor 2 is designed according to its embodiment 7, wherein the precursor exterior surface comprises a lateral surface of the tube.

In an embodiment 21 of the container precursor 1 according to the invention, the container precursor 1 is designed according to any of its preceding embodiments, and in an embodiment 9 of the container precursor 2 according to the invention, the container precursor 2 is designed according to any of its preceding embodiments, wherein in each case the wall of glass encloses the interior volume of the container precursor across at least 90%, preferably across at least 95%, most preferably at least 99%, of a surface area of the interior volume. Here, the wall of glass is, preferably, of a one-piece design. In a preferred aspect of the invention, the wall of glass fully encloses the interior volume, except for a hole which has been formed, for example by drilling, in the wall of glass for venting. Preferably, the hole for venting has a diameter in the range from 1 to 3 mm.

In an embodiment 22 of the container precursor 1 according to the invention, the container precursor 1 is designed according to any of its preceding embodiments, and in an embodiment 10 of the container precursor 2 according to the invention, the container precursor 2 is designed according to any of its preceding embodiments, wherein in each case the glass of the wall of glass is of a type selected from the group consisting of a type I glass, a borosilicate glass, an aluminosilicate glass and fused silica.

In an embodiment 23 of the container precursor 1 according to the invention, the container precursor 1 is designed according to any of its preceding embodiments, and in an embodiment 11 of the container precursor 2 according to the invention, the container precursor 2 is designed according to any of its preceding embodiments, wherein in each case the container precursor has a transmission coefficient for a transmission of light of a wavelength in a range from 400 nm to 2300 nm, preferably from 400 to 500 nm, more preferably from 430 to 490 nm, through the container precursor via the interior volume, of more than 0.7, preferably more than 0.75, more preferably more than 0.8 most preferably more than 0.82. The preceding transmission coefficient applies, preferably, for a transmission of the light in a direction which is perpendicular to a length and through a central axis of the container precursor. Further preferably, the light transmits the wall of glass of the container precursor two times, first through the wall of glass into the interior volume and then a second time through another part of the wall of glass out of the interior volume.

In an embodiment 24 of the container precursor 1 according to the invention, the container precursor 1 is designed according to any of its preceding embodiments, and in an embodiment 12 of the container precursor 2 according to the invention, the container precursor 2 is designed according to any of its preceding embodiments, wherein in each case the container precursor has a haze for a transmission of light through the container precursor via the interior volume in a range from 5 to 50%, preferably from 10 to 40%, more preferably from 10 to 35%, more preferably from 15 to 25%, preferably from 15 to 22%. The preceding haze applies, preferably, for a transmission of the light in a direction which is perpendicular to a length and through a central axis of the container precursor. Further preferably, the light transmits the wall of glass of the container precursor two times, first through the wall of glass into the interior volume and then a second time through another part of the wall of glass out of the interior volume.

A contribution to solving at least one of the objects according to the invention is made by an embodiment 1 of an arrangement, comprising a packaging, and a multitude of container precursors, packaged in the packaging, wherein the container precursors of the multitude of container precursors are designed according to any embodiment of the container precursor 1 or 2 of the invention.

In an embodiment 2 of the arrangement according to the invention, the arrangement is designed according to its embodiment 1, wherein the packaging comprises at least one envelope, wherein the multitude of container precursors is at least partially wrapped in the at least one envelope such that the at least one envelope fixes the container precursors relative to one another.

In an embodiment 3 of the arrangement according to the invention, the arrangement is designed according to its embodiment 2, wherein the envelope comprises a foil. A preferred foil is a plastic foil. A preferred plastic foil is a shrink foil.

In an embodiment 4 of the arrangement according to the invention, the arrangement is designed according to any of its preceding embodiments, wherein each container precursor of the multitude of container precursors comprises a tube, wherein the tubes form a bundle.

In an embodiment 5 of the arrangement according to the invention, the arrangement is designed according to its embodiment 4, wherein the packaging comprises a first envelope and a further envelope, wherein the bundle comprises a first longitudinal end, which is wrapped in the first envelope, and a further longitudinal end, which is wrapped in the further envelope.

In an embodiment 6 of the arrangement according to the invention, the arrangement is designed according to its embodiment 4 or 5, wherein in the bundle the tubes are hexagonally packed.

In an embodiment 7 of the arrangement according to the invention, the arrangement is designed according to any of its preceding embodiments, wherein the packaging comprises at least one spacer element, wherein the at least spacer element spaces at least two of the container precursors of the multitude of container precursors from one another such that the walls of glass of the at least two container precursors do not touch.

In an embodiment 8 of the arrangement according to the invention, the arrangement is designed according to any of its preceding embodiments, wherein the packaging further comprises a case, wherein the multitude of container precursors is disposed in the case. A preferred case is a box. A preferred box is a cardboard box.

A contribution to solving at least one of the objects according to the invention is made by an embodiment 1 of a process 1 for preparing a functionalised container precursor, the process 1 comprising as process steps: provision of a container precursor, comprising a wall of glass which at least partially encloses an interior volume of the container precursor; superimposing at least a part of the wall of glass on a side of the wall of glass which faces away from the interior volume with a composition, comprising: a first plurality of particles, and a vehicle; and decreasing a proportion of the vehicle in the composition, thereby leaving at least a part of the first plurality of particles, or a further plurality of particles, which is obtained in the process step c) from at least a part of the first plurality of particles, or a combination of the first and the further plurality of particles superimposed on the wall of glass.

Preferably, in the process step c) the wall of glass, or the first plurality of particles, or both, at least partially has a temperature in a range from 15 to 650° C., preferably from 20 to 650° C., more preferably from 25 to 650° C., more preferably from 30 to 650° C., more preferably from 50 to 650° C., more preferably from 100 to 650° C., more preferably from 150 to 650° C., more preferably from 150 to 600° C., more preferably from 150 to 500° C., more preferably from 150 to 400° C., even more preferably from 150 to 350° C., most preferably from 200 to 300° C. The temperature is preferably kept in one of the preceding ranges for a duration in a range from 1 min to 24 h, more preferably from 1 min to 12 h, more preferably from 3 min to 6 h, even more preferably from 3 min to 3 h, most preferably from 5 min to 3 h. Preferably, the particles of the further plurality of particles are obtainable from the particles of the first plurality of particles via a chemical reaction. Here, a preferred chemical reaction is an oxidation. Preferably, in the process step b) the composition comprises the vehicle at a proportion in a range from 50 to 99.9 wt.-%, more preferably 80 to 99.5 wt.-%, most preferably 90 to 99.5 wt.-%, based on the weight of the composition in the process step b). Preferably, in the process step c), the proportion of the vehicle in the composition is decreased by at least 50, more preferably at least 60, more preferably at least 70, more preferably at least 80%, even more preferably at least 90, most preferably at least 95, in each case based on a proportion of the vehicle in the composition in the process step b). Preferably, in the process step c), the proportion of the vehicle in the composition is decreased to a value in a range from 0 to 50 wt.-%, more preferably 0 to 40 wt.-%, more preferably 0 to 30 wt.-%, more preferably 0 to 20 wt.-%, more preferably 0 to 10 wt.-%, more preferably 0 to 5 wt.-%, most preferably 0 to 1 wt.-%, in each case based on the weight of the residuals of the composition which are left superimposed on the wall of glass after the process step c). In a particularly preferred embodiment, the process step c) comprises completely evaporating the vehicle from the composition. Preferably, the particles which are left superimposed on the wall of glass in the process step c) are not superimposed by any component of the container precursor on a side of the particles which faces away from the wall of glass. Particularly preferable, these particles are not embedded in any material, such as a matrix, for example a polymer matrix. Preferably, the particles adjoin an environment of the container precursor. Preferably, in the process step b) the composition does not comprise any component other than the first plurality of particles which is left as such or in form of a component obtained therefrom through the process step c) superimposed on the wall of glass at a proportion of more than 10 wt.-%, preferably more than 5 wt.-%, more preferably more than 3 wt.-%, most preferably more than 1 wt.-%, based on the weight of the residuals of the composition which are left superimposed on the wall of glass after the process step c). Hence, the residuals of the composition which are left superimposed on the wall of glass after the process step c) do not comprise any component which is different from the particles of the first and the further plurality of particles at a proportion of more than 10 wt.-%, preferably more than 5 wt.-%, more preferably more than 3 wt.-%, most preferably more than 1 wt.-%, based on the weight of these residuals. Further preferably, the particles of the first and the further plurality of particles together make up at least 90 wt.-%, preferably at least 95 wt.-%, more preferably at least 97 wt.-%, most preferably at least 99 wt.-%, in each case of a weight of the residuals of the composition which are left superimposed on the wall of glass after the process step c). In a preferred embodiment, after the process step c) the at least part of the particles of the first plurality of particles, or the further plurality of particles, or both are directly joined to the wall of glass via Van-der-Waals forces, but not via covalent bonds.

In an embodiment 2 of the process 1 according to the invention, the process 1 is designed according to its embodiment 1, wherein the functionalised container precursor is the container precursor 1 or 2 of the invention according to any of its embodiments.

In an embodiment 3 of the process 1 according to the invention, the process 1 is designed according to its embodiment 1 or 2, wherein the wall of glass has an interior surface which faces the interior volume, and an exterior surface which faces away from the interior volume; wherein in the process step b) the wall of glass is superimposed with the composition on the exterior surface.

In a preferred embodiment, in the process step b) the wall of glass is not superimposed with the composition in any part region of the interior surface. Hence, it is preferred that the wall of glass is not superimposed by any particle of the first plurality of particles towards the interior surface. Preferably, in the process step b) the composition is superimposed on the wall of glass across an area which is at least 10%, preferably at least 20%, more preferably at least 30%, more preferably at least 40%, more preferably at least 50%, more preferably at least 60%, more preferably at least 70%, more preferably at least 80%, even more preferably at least 90%, in each case of a total surface area of the exterior surface, most preferably across the full exterior surface.

In an embodiment 4 of the process 1 according to the invention, the process 1 is designed according to any of its preceding embodiments, wherein in the process step b) the composition comprises the first plurality of particles in a proportion in a range from 0.1 to 25 wt.-%, preferably from 1 to 15 wt.-%, more preferably from 2 to 8 wt.-%, in each case based on the weight of the composition in the process step b).

In an embodiment 5 of the process 1 according to the invention, the process 1 is designed according to any of its preceding embodiments, wherein in the process step b) the composition is a dispersion. A preferred dispersion is a suspension, or a colloid, or both, wherein a suspension is particularly preferred.

In an embodiment 6 of the process 1 according to the invention, the process 1 is designed according to any of its preceding embodiments, wherein the vehicle is an organic vehicle, or an inorganic vehicle, or both. A preferred organic vehicle comprises alkyl groups with less than 7 C-atoms. Additionally or alternatively preferred, the organic vehicle is an alcohol. A preferred alcohol is ethanol, or isopropanol, or both. A preferred inorganic vehicle is water. Further preferably, the vehicle is a solvent.

In an embodiment 7 of the process 1 according to the invention, the process 1 is designed according to any of its preceding embodiments, wherein in the process step b) the wall of glass is contacted with the composition. Preferably, in the process step c) the particles of the first plurality of particles, or of the further plurality of particles, or both are joined to the wall of glass, preferably by establishing Van-der-Waals forces, or covalent bonds, or both between the respective particles and the wall of glass. Here, preferred covalent bonds are Si—O-bonds. In a preferred Si—O-bond, the Si is bonded via one O, or via two O to the wall of glass.

In an embodiment 8 of the process 1 according to the invention, the process 1 is designed according to any of its preceding embodiments, wherein the composition further comprises a dispersing agent, or a chemical bonding agent, or both. A preferred dispersing agent has a kinematic viscosity in a range from 1·10⁻⁷ to 100·10⁻⁷ m²/s, preferably from 1·10⁻⁷ to 50·10⁻⁷ m²/s, more preferably from 1.10⁻⁷ to 30·10⁻⁷ m²/s, most preferably from 3·10⁻⁷ to 12.10⁻⁷ m²/s, in each case at 20° C. A preferred chemical bonding agent is an alkoxysilane or a chlorosilane or both.

In an embodiment 9 of the process 1 according to the invention, the process 1 is designed according to any of its preceding embodiments, wherein prior to the process step b) the process comprises a step of pre-hydrolising the first plurality of particles.

In an embodiment 10 of the process 1 according to the invention, the process 1 is designed according to its embodiment 9, wherein the pre-hydrolising comprises at least partially contacting the first plurality of particles with a chemical bonding agent. A preferred chemical bonding agent is an alkoxysilane or a chlorosilane or both.

In an embodiment 11 of the process 1 according to the invention, the process 1 is designed according to its embodiment 9 or 10, wherein the pre-hydrolising comprises adjusting, preferably heating, a temperature of the first plurality of particles to be in a range from 15 to 45° C.

In an embodiment 12 of the process 1 according to the invention, the process 1 is designed according to any of its preceding embodiments, wherein the particles of the first plurality of particles, or of the further plurality of particles, or both at least partially have a decomposition temperature of more than 500° C., preferably more than 600° C., more preferably more than 700° C., more preferably more than 800° C., more preferably more than 900° C., more preferably more than 1,000° C., more preferably more than 1,100° C., more preferably more than 1,200° C., more preferably more than 1,300° C., most preferably more than 1,400° C. Preferably, the decomposition temperature is not more than 2,000° C., more preferably not more than 1,900° C., most preferably not more than 1,800° C. Further, what has been said about the decomposition temperature in the context of embodiment 3 of the container precursor 1, preferably, applies.

In an embodiment 13 of the process 1 according to the invention, the process 1 is designed according to any of its preceding embodiments, wherein the first plurality of particles is characterised by a first particle size distribution having a D₅₀ in a range from 1 to 100 μm, preferably from 1 to 80 μm, more preferably from 1 to 60 μm, more preferably from 1 to 40 μm, more preferably from 1 to 20 μm, more preferably from 1 to 15 μm, even more preferably from 2 to 10 μm, most preferably from 2 to 6 μm. In a preferred embodiment, the D₅₀ of the first particle size distribution is in an range from 2 to 100 μm, preferably from 2 to 80 μm, more preferably from 2 to 60 μm, more preferably from 2 to 40 μm, more preferably from 2 to 20 μm, more preferably from 2 to 15 μm, even more preferably from 2 to 10 μm, most preferably from 2 to 6 μm. Preferably, the further plurality of particles is characterised by a further particle size distribution having a D₅₀ in a range from 1 to 100 μm, preferably from 1 to 80 μm, more preferably from 1 to 60 μm, more preferably from 1 to 40 μm, more preferably from 1 to 20 μm, more preferably from 1 to 15 μm, even more preferably from 2 to 10 μm, most preferably from 2 to 6 μm. In a preferred embodiment, the D₅₀ of the further particle size distribution is in an range from 2 to 100 μm, preferably from 2 to 80 μm, more preferably from 2 to 60 μm, more preferably from 2 to 40 μm, more preferably from 2 to 20 μm, more preferably from 2 to 15 μm, even more preferably from 2 to 10 μm, most preferably from 2 to 6 μm. Preferably, the D₅₀ of the further particle size distribution is less than the D₅₀ of the first particle size distribution, more preferably by at least 100 nm, more preferably at least 500 nm, most preferably at least 800 nm, but typically not more than 2 μm, preferably not more than 1 μm. In a preferred embodiment, the particle size distribution of the first plurality of particles, additionally, has a D₁₀ in an range from 0.1 to 50 μm, preferably from 0.5 to 10 μm, more preferably from 0.5 to 5 μm, most preferably from 1 to 3 μm; or a D₉₀ in an range from 0.5 to 100 μm, preferably from 0.5 to 50 μm, more preferably from 1 to 20 μm, most preferably from 2 to 10 μm; or both. In a further preferred embodiment, the particle size distribution of the further plurality of particles, additionally, has a D₁₀ in an range from 0.1 to 50 μm, preferably from 0.5 to 10 μm, more preferably from 0.5 to 5 μm, most preferably from 1 to 3 μm; or a D₉₀ in an range from 0.5 to 100 μm, preferably from 0.5 to 50 μm, more preferably from 1 to 20 μm, most preferably from 2 to 10 μm; or both.

In an embodiment 14 of the process 1 according to the invention, the process 1 is designed according to any of its preceding embodiments, wherein the particles of the first plurality of particles, or the particles of the further plurality of particles, or both are selected from the group consisting of organic particles, inorganic particles, and hybrid polymer particles, or a combination of at least two thereof. In a preferred embodiment, the particles of the first plurality of particles are organic particles, or hybrid polymer particles, or a mixture of both. Additionally or alternately preferred, the particles of the further plurality of particles are inorganic particles. Here, a combination of at least two of the preceding types of particles refers to a situation in which the first or the further plurality of particles or each of both or both in combination comprises particles of at least two different types from one of the preceding lists.

In an embodiment 15 of the process 1 according to the invention, the process 1 is designed according to its embodiment 14, wherein the inorganic particles comprise one selected from the group consisting of a boron nitride, a molybdenum sulphide, a silicon nitride, an oxide, and a compound which includes covalently bonded H, or a combination of at least two thereof. A preferred molybdenum sulphide is MoS₂. A preferred silicon nitride is Si₃N₄. A preferred oxide is a silicon oxide or a titanium oxide or both. A preferred silicon oxide is SiO₂. A preferred titanium oxide is TiO₂. A preferred inorganic compound which includes covalently bonded H is a siloxane, or a silane, or both.

In an embodiment 16 of the process 1 according to the invention, the process 1 is designed according to its embodiment 14 or 15, wherein the organic particles comprise a compound which includes covalently bonded H. A preferred organic compound which includes covalently bonded H is a polymer of one or more siloxanes, or an organo-silane, or both. Additionally or alternatively preferred, organic particles which comprise a compound which includes covalently bonded H comprise this compound as part of a latex, or of a silicone resin, or both.

In an embodiment 17 of the process 1 according to the invention, the process 1 is designed according to any of its embodiments 14 to 16, wherein the hybrid polymer particles comprise a compound which includes covalently bonded H. A preferred hydrbridpolymer compound which includes covalently bonded H is a hybridpolymer silane, or a hybridpolymer siloxane, or both. A preferred hybridpolymer siloxane is a polyorganosiloxane, more preferably a polyalkylsiloxane or a polysilsesquioxane or both.

In an embodiment 18 of the process 1 according to the invention, the process 1 is designed according to any of its preceding embodiments, wherein the particles of the first plurality of particles, or the particles of the further plurality of particles, or both comprise a compound which includes covalently bonded H. A preferred compound including covalently bonded H is a silane, or a siloxane, or both. A preferred silane is an inorganic silane, or a hybridpolymer silane, wherein a hybridpolymer silane is particularly preferred. A preferred siloxane is one selected from the group consisting of an inorganic siloxane, a polymer of one or more siloxanes, an organo-silane, and a hybrid-polymer siloxane or both, wherein a hybridpolymer siloxane is particularly preferred. Additionally or alternatively preferred, particles which comprise a compound which includes covalently bonded H comprise this compound as part of a latex, or of a silicone resin, or both.

In an embodiment 19 of the process 1 according to the invention, the process 1 is designed according to any of its preceding embodiments, wherein after the process step c) the at least part of the first plurality of particles, or the at least part of the further plurality of particles, or both in combination superimposes the wall of glass at a surface cover ratio in a range from 1 to 50%, preferably at 5 to 40%, more preferably at 5 to 35%, more preferably at 10 to 30%, most preferably at 10 to 25%, in each case based on a surface area of a region of the wall of glass which is superimposed by the respective plurality of particles.

In an embodiment 20 of the process 1 according to the invention, the process 1 is designed according to any of its preceding embodiments, wherein the first plurality of particles is characterised by a first particle size distribution, wherein the first particle size distribution has a full width at half maximum which is less than 30%, preferably less than 25%, more preferably less than 20%, even more preferably less than 15%, most preferably less than 10%, in each case of a D₅₀ of the first particle size distribution. Preferably, also a further particle size distribution of the further plurality of particles has a full width at half maximum which is less than 30%, preferably less than 25%, more preferably less than 20%, even more preferably less than 15%, most preferably less than 10%, in each case of a D₅₀ of the further particle size distribution.

In an embodiment 21 of the process 1 according to the invention, the process 1 is designed according to any of its preceding embodiments, wherein the particles of the first plurality of particles, or the particles of the further plurality of particles, or both are characterised by an aspect ratio in a range from 0.5 to 1.5, preferably from 0.6 to 1.4, more preferably from 0.7 to 1.3, more preferably from 0.8 to 1.2, most preferably from 0.9 to 1.1. Particularly preferable, the particles of the first plurality of particles, or the particles of the further plurality of particles, or both are spherical.

In an embodiment 22 of the process 1 according to the invention, the process 1 is designed according to any of its preceding embodiments, wherein the superimposing in the process step b) comprises one selected from the group consisting of a spraying, a dipping, and a printing, or a combination of at least two thereof.

In an embodiment 23 of the process 1 according to the invention, the process 1 is designed according to any of its preceding embodiments, wherein the glass of the wall of glass is of a type selected from the group consisting of a type I glass, a borosilicate glass, an aluminosilicate glass, and fused silica.

In an embodiment 24 of the process 1 according to the invention, the process 1 is designed according to any of its preceding embodiments, wherein the wall of glass has a precursor exterior surface which faces away from the interior volume, wherein the process step b), or c), or both comprises adjusting a coefficient of dry sliding friction of at least a part of the precursor exterior surface to be less than 0.25, preferably less than 0.20, more preferably less than 0.18, more preferably less than 0.16, more preferably less than 0.15, more preferably less than 0.12, more preferably less than 0.10, more preferably less than 0.05, more preferably less than 0.03, most preferably less than 0.02.

In an embodiment 25 of the process 1 according to the invention, the process 1 is designed according to any of its preceding embodiments, wherein the wall of glass has a precursor exterior surface which faces away from the interior volume, wherein the process step b), or c), or both comprises adjusting a contact angle for wetting with water of at least part of the precursor exterior surface to a value in a range from 0 to 45°, preferably from 5 to 45°, more preferably 10 to 45°.

In an embodiment 26 of the process 1 according to the invention, the process 1 is designed according to any of its preceding embodiments, wherein in the process step b) the wall of glass has a temperature which is less than a softening temperature of the glass of the wall of glass, preferably less than a transformation temperature T_{g} of the glass of the wall of glass, in each case, preferably by at least 10° C., more preferably at least 20° C., more preferably at least 30° C., more preferably at least 50° C., most preferably at least 100° C.

In an embodiment 27 of the process 1 according to the invention, the process 1 is designed according to any of its preceding embodiments, wherein in the process step b) the wall of glass has a temperature in a range from 10 to 600° C., preferably from 100 to 600° C., more preferably from 150 to 500° C., most preferably from 200 to 400° C. In a preferred embodiment, the preceding temperature is in a range from 200 to 600° C., more preferably from 300 to 550° C., most preferably from 400 to 500° C. In a further preferred embodiment, the preceding temperature is in a range from 10 to 500° C., preferably from 20 to 500° C., more preferably from 100 to 450° C., more preferably from 150 to 400° C., most preferably from 200 to 300° C.

In an embodiment 28 of the process 1 according to the invention, the process 1 is designed according to any of its preceding embodiments, wherein in the process step a) the container precursor has length in a range from 0.1 to 100 m. Preferably, in the process step a) the container precursor has length in a range from 5 to 100 m, more preferably from 7.5 to 60 m, most preferably from 10 to 50 m. In a further preferred embodiment, the container precursor has length in a range from 0.1 to 10 m, preferably from 0.1 to 5 m, more preferably from 0.5 to 3 m, most preferably from 1 to 2 m.

In an embodiment 29 of the process 1 according to the invention, the process 1 is designed according to any of its preceding embodiments, wherein in the process step a) the container precursor has an outer diameter in a range from 5 to 55 mm, preferably in a range from 6 to 50 mm, more preferably from 10 to 42 mm. A particularly preferred container precursor has an outer diameter of 16 mm or 30 mm.

In an embodiment 30 of the process 1 according to the invention, the process 1 is designed according to any of its preceding embodiments, wherein in the process step a) the container precursor has an inner diameter in a range from 4 to 50 mm, preferably in a range from 8 to 38 mm, more preferably from 10 to 30 mm. A particularly preferred container precursor has an inner diameter of 14 mm or 27 mm.

In an embodiment 31 of the process 1 according to the invention, the process 1 is designed according to any of its preceding embodiments, wherein the container precursor comprises a tube, wherein the wall of glass constitutes at least a wall of the tube. In a preferred embodiment, the container precursor consists of the tube.

In an embodiment 32 of the process 1 according to the invention, the process 1 is designed according to its embodiment 31, wherein in the process step b) the at least part of the wall of glass is at least a part of a lateral surface of the tube.

In an embodiment 33 of the process 1 according to the invention, the process 1 is designed according to any of its preceding embodiments, wherein the process step a) comprises forming the wall of glass from a glass melt. Preferably, forming the wall of glass from the glass melt comprises drawing a tube from the glass melt.

In an embodiment 34 of the process 1 according to the invention, the process 1 is designed according to any of its preceding embodiments, wherein in the process step a) the container precursor at least partially, preferably fully, has a temperature which is more than a transformation temperature T_{g} of the glass of the wall of glass, preferably more than a softening temperature of the glass of the wall of glass, in each case preferably by at least 10° C., more preferably at least 20° C., more preferably at least 30° C., more preferably at least 50° C., most preferably at least 100° C. In a preferred aspect of the process 1, the container precursor is drawn from a glass melt, preferably as a strand, in the process step a). In that case, a first end of the container precursor which has just been drawn from the glass melt, preferably, has a temperature in the range from 800 to 900° C., whereas an opposite end of the container precursor, preferably, has a temperature in the range from 200 to 300° C. Particularly preferred, the container precursor at least partially, preferably fully, still has a temperature in accordance with one of the preceding definitions in the process step c).

In an embodiment 35 of the process 1 according to the invention, the process 1 is designed according to any of its preceding embodiments, wherein in the process step c) a raw functionalised container precursor is obtained, wherein the process further comprises a process step d) of separating the raw functionalised container precursor into a multitude of functionalised container precursors, wherein the multitude of functionalised container precursors comprises the functionalised contamer precursor.

In an embodiment 36 of the process 1 according to the invention, the process 1 is designed according to its embodiment 35, wherein the raw functionalised container precursor comprises, preferably consists of, a raw functionalised tube, wherein the multitude of functionalised container precursors comprises a multitude of functionalised tubes, wherein the functionalised container precursor comprises a functionalised tube of the multitude of functionalised tubes.

In an embodiment 37 of the process 1 according to the invention, the process 1 is designed according to its embodiment 36, wherein the raw functionalised tube has length in a range from 5 to 100 m, more preferably from 7.5 to 60 m, most preferably from 10 to 50 m.

In an embodiment 38 of the process 1 according to the invention, the process 1 is designed according to its embodiment 36 or 37, wherein the functionalised tube which is included by the functionalised container precursor has length in a range from 0.1 to 10 m, more preferably from 0.1 to 5 m, more preferably from 0.5 to 3 m, most preferably from 1 to 2 m.

In an embodiment 39 of the process 1 according to the invention, the process 1 is designed according to any of its embodiments 35 to 38, wherein the process further comprises a process step e) of closing the functionalised container precursor. The closing is preferably affected by at least partly heating the wall of glass to a temperature which is more than a transformation temperature T_{g} of the glass of the wall of glass, preferably more than a softening temperature of the glass of the wall of glass, in each case preferably by at least 10° C., more preferably at least 20° C., more preferably at least 30° C., more preferably at least 50° C., most preferably at least 100° C., and partly reshaping the wall of glass, thereby sealing the functionalised container precursor.

In an embodiment 40 of the process 1 according to the invention, the process 1 is designed according to any of its embodiments 35 to 39, wherein the raw functionalised container precursor or the functionalised container precursor or each of both is of a one piece design.

In an embodiment 41 of the process 1 according to the invention, the process 1 is designed according to any of its embodiments 1 to 33, wherein the process step a) comprises as sub-steps
a. a1) provision of a raw container precursor, and
b. a2) separating the raw container precursor into a multitude of container precursors, wherein the multitude of container precursors comprises the container precursor.

In an embodiment 42 of the process 1 according to the invention, the process 1 is designed according to its embodiment 41, wherein in the sub-step al) the raw container precursor has a temperature which is more than a transformation temperature T_{g} of the glass of the wall of glass, preferably more than a softening temperature of the glass of the wall of glass, in each case preferably by at least 10° C., more preferably at least 20° C., more preferably at least 30° C., more preferably at least 50° C., most preferably at least 100° C. In a preferred aspect of the process 1, the raw container precursor is drawn from a glass melt, preferably as a strand, in the process step al). In that case, a first end of the raw container precursor which has just been drawn from the glass melt, preferably, has a temperature in the range from 800 to 900° C., whereas an opposite end of the raw container precursor, preferably, has a temperature in the range from 200 to 300° C.

In an embodiment 43 of the process 1 according to the invention, the process 1 is designed according to its embodiment 41 or 42, wherein the raw container precursor has length in a range from 5 to 100 m, more preferably from 7.5 to 60 m, most preferably from 10 to 50 m.

In an embodiment 44 of the process 1 according to the invention, the process 1 is designed according to any of its embodiments 41 to 43, wherein the raw container precursor comprises, preferably consists of, a raw tube.

In an embodiment 45 of the process 1 according to the invention, the process 1 is designed according to any of its embodiments 41 to 44, wherein the process step a) further comprises a sub-step a3) of closing the container precursor. The closing is preferably affected by at least partly heating the wall of glass to a temperature which is more than a transformation temperature T_{g} of the glass of the wall of glass, preferably more than a softening temperature of the glass of the wall of glass, in each case preferably by at least 10° C., more preferably at least 20° C., more preferably at least 30° C., more preferably at least 50° C., most preferably at least 100° C., and partly reshaping the wall of glass, thereby sealing the container precursor.

In an embodiment 46 of the process 1 according to the invention, the process 1 is designed according to any of its embodiments 41 to 45, wherein in the process step a) the wall of glass encloses the interior volume of the container precursor across at least 90%, preferably across at least 95%, most preferably at least 99%, of a surface area of the interior volume. Here, the wall of glass is, preferably, of a one-piece design. In a preferred aspect of the invention, the wall of glass fully encloses the interior volume, except for a hole for venting. The hole for venting has, preferably, been formed in the wall of glass by drilling into the wall of glass, or, alternatively preferable, by burning the wall of glass using a spot burner. Preferably, the hole for venting has a diameter in the range from 1 to 3 mm.

In an embodiment 47 of the process 1 according to the invention, the process 1 is designed according to any of its preceding embodiments, wherein the container precursor is of a one piece design. Additionally or alternatively preferred, the raw container precursor is of a one piece design.

A contribution to solving at least one of the objects according to the invention is made by an embodiment 1 of a functionalised container precursor obtainable by the process 1 according to any of its embodiments. In a preferred embodiment, the functionalised container precursor obtainable has the features of the container precursor 1 or 2 of the invention, in each case according to any of its embodiments.

A contribution to solving at least one of the objects according to the invention is made by an embodiment 1 of a container 1, comprising a wall of glass which forms a hollow glass body which at least partially encloses an interior volume of the container; wherein the hollow glass body comprises in a direction of a length of the hollow glass body, a first end region, a body region, and a further end region; wherein in the body region, on a side of the wall of glass which faces away from the interior volume the wall of glass is at least partially superimposed by a plurality of particles; wherein in the first end region, or in the further end region, or in each of both, in each case on the side of the wall of glass which faces away from the interior volume, the wall of glass is not superimposed by any part of the plurality of particles. The first end region of the container is preferably a top region. The further end region of the container is preferably a bottom region. Here, the direction of the length of the hollow glass body is preferably a direction of a height of the hollow glass body. Particularly preferable, in the bottom region, on the side of the wall of glass which faces away from the interior volume the wall of glass is not superimposed by any part of the plurality of particles. Preferably, in the bottom region, on the side of the wall of glass which faces away from the interior volume the wall of glass is not superimposed by any particle which is joined to the wall of glass. In a preferred embodiment, the particles of the plurality of particles are directly joined to the wall of glass via Van-der-Waals forces, but not via covalent bonds. In a preferred embodiment, the wall of glass is not superimposed by the plurality of particles on a side of the wall of glass which faces the interior volume. Hence, it is preferred that no particle of the plurality of particles superimposes the wall of glass on a side which faces the interior volume. Preferably, the plurality of particles superimposes the wall of glass on an area which is at least 10%, preferably at least 20%, more preferably at least 30%, more preferably at least 40%, more preferably at least 50%, more preferably at least 60%, more preferably at least 70%, more preferably at least 80%, even more preferably at least 90%, in each case of a total surface area of the hollow glass body which faces away from the interior volume in the body region, most preferably across the full surface area of the hollow glass body which faces away from the interior volume in the body region.

In a preferred embodiment of the container 1, in the body region a surface of the hollow glass body which faces away from the interior volume is at least partially characterised by a coefficient of dry sliding friction; wherein in the first end region a surface of the hollow glass body which faces away from the interior volume is at least partially characterised by a first coefficient of static friction; wherein in the further end region a surface of the hollow glass body which faces away from the interior volume is at least partially characterised by a further coefficient of static friction; wherein a ratio of the coefficient of dry sliding friction to the first coefficient of static friction, or a ratio of the coefficient of dry sliding friction to the further coefficient of static friction, or each of both is in a range from 0.01 to 0.9, preferably from 0.01 to 0.5, more preferably from 0.01 to 0.1; wherein the first coefficient of static friction, or the further coefficient of static friction, or each of both is at least 0.15, preferably at least 0.16, more preferably at least 0.17, more preferably at least 0.18, more preferably at least 0.19, more preferably at least 0.20, more preferably at least 0.21, even more preferably at least 0.22, more preferably at least 0.23, most preferably more than 0.23. Preferably, the first coefficient of static friction, or the further coefficient of static friction, or each of both is not more than 0.5, more preferably not more than 0.4, most preferably not more than 0.35. The coefficient of dry sliding friction, the first coefficient of static friction and/or the further coefficient of static friction is/are preferably in a range taught in the context of the container 2of the invention.

In an embodiment 2 of the container 1 according to the invention, the container 1 is designed according to its embodiment 1, wherein the plurality of particles is characterised by particle size distribution having a D₅₀ in a range from 1 to 100 μm, preferably from 1 to 80 μm, more preferably from 1 to 60 μm, more preferably from 1 to 40 μm, more preferably from 1 to 20 μm, more preferably from 1 to 15 μm, even more preferably from 2 to 10 μm, most preferably from 2 to 6 μm. In a preferred embodiment, the D₅₀ of the particle size distribution is in a range from 2 to 100 μm, preferably from 2 to 80 μm, more preferably from 2 to 60 μm, more preferably from 2 to 40 μm, more preferably from 2 to 20 μm, more preferably from 2 to 15 μm, even more preferably from 2 to 10 μm, most preferably from 2 to 6 μm. In a preferred embodiment, the particle size distribution of the plurality of particles, additionally, has a D₁₀ in a range from 0.1 to 50 μm, preferably from 0.5 to 10 μm, more preferably from 0.5 to 5 μm, most preferably from 1 to 3 μm; or a D₉₀ in a range from 0.5 to 100 μm, preferably from 0.5 to 50 μm, more preferably from 1 to 20 μm, most preferably from 2 to 10 μm; or both. Preferably, the plurality of particles forms at least a part of a surface of the container which faces away from the interior volume.

In an embodiment 3 of the container 1 according to the invention, the container 1 is designed according to its embodiment 1 or 2, wherein the particles of the plurality of particles at least partially have a decomposition temperature of more than 500° C., preferably more than 600° C., more preferably more than 700° C., more preferably more than 800° C., more preferably more than 900° C., more preferably more than 1,000° C., more preferably more than 1,100° C., more preferably more than 1,200° C., more preferably more than 1,300° C., most preferably more than 1,400° C. Preferably, the decomposition temperature of the particles of the plurality of particles is not more than 2,000° C., more preferably not more than 1,900° C., most preferably not more than 1,800° C. Further, what has been said about the decomposition temperature in the context of embodiment 3 of the container precursor 1, preferably, applies.

In an embodiment 4 of the container 1 according to the invention, the container 1 is designed according to any of its embodiments 1 to 3, wherein the particles of the plurality of particles are selected from the group consisting of organic particles, inorganic particles, and hybrid polymer particles, or a combination of at least two thereof. Here, a combination of at least two of the preceding types of particles refers to a plurality of particles which comprises particles of at least two different types from the preceding list. Further, the particles of the plurality of particles are particularly preferred organic particles, or hybrid polymer particles, or both.

In an embodiment 5 of the container 1 according to the invention, the container 1 is designed according to its embodiment 4, wherein the inorganic particles comprise, preferably consist of, one selected from the group consisting of a boron nitride, a molybdenum sulphide, a silicon nitride, an oxide, and a compound which includes covalently bonded H, or a combination of at least two thereof. A preferred molybdenum sulphide is MoS₂. A preferred silicon nitride is Si₃N₄. A preferred oxide is a silicon oxide or a titanium oxide or both. A preferred silicon oxide is SiO₂. A preferred titanium oxide is TiO₂. A preferred inorganic compound which includes covalently bonded H is a siloxane, or a silane, or both.

In an embodiment 6 of the container 1 according to the invention, the container 1 is designed according to its embodiment 4 or 5, wherein the organic particles comprise, preferably consist of, a compound which includes covalently bonded H. A preferred organic compound which includes covalently bonded H is a polymer of one or more siloxanes, or an organo-silane, or both. Additionally or alternatively preferred, organic particles which comprise a compound which includes covalently bonded H comprise this compound as part of a latex, or of a silicone resin, or both.

In an embodiment 7 of the container 1 according to the invention, the container 1 is designed according to any of its embodiments 4 to 6, wherein the hybrid polymer particles comprise, preferably consist of, a compound which includes covalently bonded H. A preferred hybridpolymer compound which includes covalently bonded H is a hybridpolymer silane, or a hybridpolymer siloxane, or both. A preferred hybridpolymer siloxane is a polyorganosiloxane, more preferably a polyalkylsiloxane or a polysilsesquioxane or both.

In an embodiment 8 of the container 1 according to the invention, the container 1 is designed according to any of its preceding embodiments, wherein the particles of the plurality of particles comprise, preferably consist of, a compound which includes covalently bonded H. A preferred compound including covalently bonded H is a silane, or a siloxane, or both. A preferred silane is an inorganic silane, or a hybridpolymer silane, wherein a hybridpolymer silane is particularly preferred. A preferred siloxane is one selected from the group consisting of an inorganic siloxane, a polymer of one or more siloxanes, an organo-silane, and a hybridpolymer siloxane or both, wherein a hybridpolymer siloxanes particularly preferred. Additionally or alternatively preferred, particles which comprise a compound which includes covalently bonded H comprise this compound as part of a latex, or of a silicone resin, or both.

In an embodiment 9 of the container 1 according to the invention, the container 1 is designed according to any of its preceding embodiments, wherein the particles of the plurality of particles adjoin the wall of glass. Preferably, the particles of the plurality of particles are directly joined to the wall of glass via Van-der-Waals forces, or via covalent bonds, or both. Here, preferred covalent bonds are Si—O-bonds. In a preferred Si—O-bond, the Si is bonded via one O, or via two O to the wall of glass. In a preferred embodiment, the particles of the plurality of particles are directly joined to the wall of glass via Van-der-Waals forces, but no via covalent bonds.

In an embodiment 10 of the container 1 according to the invention, the container 1 is designed according to any of its preceding embodiments, wherein the particles of the plurality of particles are not superimposed by any component of the container on a side of the particles of the plurality of particles which faces away from the wall of glass. Particularly preferable, the particles of the plurality of particles are not embedded in any material, such as a matrix, for example a polymer matrix. Preferably, the plurality of particles adjoins an environment of the container precursor.

In an embodiment 11 of the container 1 according to the invention, the container 1 is designed according to any of its preceding embodiments, wherein the plurality of particles superimposes the wall of glass at a surface cover ratio 1 to 50%, preferably at 5 to 40%, more preferably at 5 to 35%, more preferably at 10 to 30%, most preferably at 10 to 25%, in each case based on a surface area of a region of the wall of glass which is superimposed by the plurality of particles.

In an embodiment 12 of the container 1 according to the invention, the container 1 is designed according to any of its preceding embodiments, wherein the particle size distribution has a full width at half maximum (FWHM) which is less than 30%, preferably less than 25%, more preferably less than 20%, even more preferably less than 15%, most preferably less than 10%, in each case of the D₅₀ of the particle size distribution.

In an embodiment 13 of the container 1 according to the invention, the container 1 is designed according to any of its preceding embodiments, wherein the particles of the plurality of particles are characterised by an aspect ratio in a range from 0.5 to 1.5, preferably from 0.6 to 1.4, more preferably from 0.7 to 1.3, more preferably from 0.8 to 1.2, most preferably from 0.9 to 1.1. Particularly preferable, the particles of the plurality of particles are spherical.

A contribution to solving at least one of the objects according to the invention is made by an embodiment 1 of a container 2, comprising a wall of glass which forms a hollow glass body which at least partially encloses an interior volume of the container; wherein the hollow glass body comprises in a direction of a length of the hollow glass body, a first end region, a body region, and a further end region; wherein in the body region a surface of the hollow glass body which faces away from the interior volume is at least partially characterised by a coefficient of dry sliding friction; wherein in the first end region a surface of the hollow glass body which faces away from the interior volume is at least partially characterised by a first coefficient of static friction; wherein in the further end region a surface of the hollow glass body which faces away from the interior volume is at least partially characterised by a further coefficient of static friction; wherein a ratio of the coefficient of dry sliding friction to the first coefficient of static friction, or a ratio of the coefficient of dry sliding friction to the further coefficient of static friction, or each of both is in a range from 0.01 to 0.9, preferably from 0.01 to 0.5, more preferably from 0.01 to 0.1; wherein the first coefficient of static friction, or the further coefficient of static friction, or each of both is at least 0.15, preferably at least 0.16, more preferably at least 0.17, more preferably at least 0.18, more preferably at least 0.19, more preferably at least 0.20, more preferably at least 0.21, even more preferably at least 0.22, more preferably at least 0.23, most preferably more than 0.23. Preferably, the first coefficient of static friction, or the further coefficient of static friction, or each of both is not more than 0.5, more preferably not more than 0.4, most preferably not more than 0.35.

In an embodiment 2 of the container 2 according to the invention, the container 2 is designed according to its embodiment 1, wherein the coefficient of dry sliding friction is less than 0.25, preferably less than 0.20, more preferably less than 0.18, more preferably less than 0.16, more preferably less than 0.15, more preferably less than 0.12, more preferably less than 0.10, more preferably less than 0.05, more preferably less than 0.03, most preferably less than 0.02.

In an embodiment 14 of the container 1 according to the invention, the container 1 is designed according to any of its preceding embodiments, and in an embodiment 3 of the container 2 according to the invention, the container 2 is designed according to any of its preceding embodiments, wherein in each case in the body region a surface of the hollow glass body which faces away from the interior volume is at least partially characterised by a contact angle for wetting with water in a range from 0 to 45°, preferably from 5 to 45°, more preferably 10 to 45°.

In an embodiment 15 of the container 1 according to the invention, the container 1 is designed according to any of its preceding embodiments, and in an embodiment 4 of the container 2 according to the invention, the container 2 is designed according to any of its preceding embodiments, wherein in each case throughout the body region a thickness of the wall of glass is in a range from ±0.3 mm, preferably ±0.2 mm, more preferably ±0.1 mm, most preferably ±0.08 mm, in each case based on a mean value of this thickness in the body region.

In an embodiment 16 of the container 1 according to the invention, the container 1 is designed according to any of its preceding embodiments, and in an embodiment 5 of the container 2 according to the invention, the container 2 is designed according to any of its preceding embodiments, wherein in each case throughout the body region a thickness of the wall of glass is in a range from 0.5 to 2 mm, more preferably from 0.6 to 1.7 mm, most preferably from 0.9 to 1.6 mm. In a preferred embodiment throughout the body region a thickness of the wall of glass is in a range from 0.9 to 1.1 mm. In a further preferred embodiment throughout the body region a thickness of the wall of glass is in a range from 1.5 to 1.7 mm.

In an embodiment 17 of the container 1 according to the invention, the container 1 is designed according to any of its preceding embodiments, and in an embodiment 6 of the container 2 according to the invention, the container 2 is designed according to any of its preceding embodiments, wherein in each case in the body region the hollow glass body is a hollow cylinder.

In an embodiment 18 of the container 1 according to the invention, the container 1 is designed according to any of its preceding embodiments, and in an embodiment 7 of the container 2 according to the invention, the container 2 is designed according to any of its preceding embodiments, wherein in each case the interior volume is in a range from 0.5 to 100 ml, preferably from 1 to 100 ml, more preferably from 1 to 50 ml, even more preferably from 1 to 10 ml, most preferably from 2 to 10 ml.

In an embodiment 19 of the container 1 according to the invention, the container 1 is designed according to any of its preceding embodiments, and in an embodiment 8 of the container 2 according to the invention, the container 2 is designed according to any of its preceding embodiments, wherein in each case the container is a packaging container for a medical or a pharmaceutical packaging good or both. Preferably, the container is a primary packaging container for a medical or a pharmaceutical packaging good or both. A preferred pharmaceutical packaging good is a pharmaceutical composition. Preferably, the container is suitable for packaging parenteralia in accordance with section 3.2.1 of the European Pharmacopoeia, 7^{th} edition from 2011.

In an embodiment 20 of the container 1 according to the invention, the container 1 is designed according to any of its preceding embodiments, and in an embodiment 9 of the container 2 according to the invention, the container 2 is designed according to any of its preceding embodiments, wherein in each case the container is one selected from the group consisting of a vial, a syringe, a cartridge, and an ampoule; or a combination of at least two thereof.

In an embodiment 21 of the container 1 according to the invention, the container 1 is designed according to any of its preceding embodiments, and in an embodiment 10 of the container 2 according to the invention, the container 2 is designed according to any of its preceding embodiments, wherein in each case the glass of the wall of glass is of a type selected from the group consisting of a type I glass, a borosilicate glass, an aluminosilicate glass, and fused silica.

In an embodiment 22 of the container 1 according to the invention, the container 1 is designed according to any of its preceding embodiments, and in an embodiment 11 of the container 2 according to the invention, the container 2 is designed according to any of its preceding embodiments, wherein in each case the container has a transmission coefficient for a transmission of light of a wavelength in a range from 400 nm to 2300 nm, preferably from 400 to 500 nm, more preferably from 430 to 490 nm, through any part of the body region, of more than 0.7, preferably more than 0.75, more preferably more than 0.8 most preferably more than 0.82.

In an embodiment 23 of the container 1 according to the invention, the container 1 is designed according to any of its preceding embodiments, and in an embodiment 12 of the container 2 according to the invention, the container 2 is designed according to any of its preceding embodiments, wherein in each case the container has a haze for a transmission of light through any part of the body region in a range from 5 to 50%, preferably from 10 to 40%, more preferably from 10 to 35%, more preferably from 15 to 25%, preferably from 15 to 22%.

In an embodiment 24 of the container 1 according to the invention, the container 1 is designed according to any of its preceding embodiments, and in an embodiment 13 of the container 2 according to the invention, the container 2 is designed according to any of its preceding embodiments, wherein in each case towards the interior volume the wall of glass is at least partially superimposed by an alkali metal barrier layer, or by a hydrophobic layer, or both.

In an embodiment 25 of the container 1 according to the invention, the container 1 is designed according to any of its preceding embodiments, and in an embodiment 14 of the container 2 according to the invention, the container 2 is designed according to any of its preceding embodiments, wherein in each case the container is obtainable from the container precursor 1 or 2 according to any of its embodiments or from the functionalised container precursor of the invention.

In an embodiment 26 of the container 1 according to the invention, the container 1 is designed according to any of its preceding embodiments, and in an embodiment 15 of the container 2 according to the invention, the container 2 is designed according to any of its preceding embodiments, wherein in each case the interior volume comprises a pharmaceutical composition.

A contribution to solving at least one of the objects according to the invention is made by an embodiment 1 of a process 2 for preparing a functionalised container, the process 2 comprising as process steps: provision of the container precursor 1 or 2 according to any of its embodiments; at least partially heating the container precursor above a transformation temperature T_{g} of the glass of the wall of glass, preferably above a softening temperature of the glass of the wall of glass, in each case preferably by at least 10° C., more preferably at least 20° C., more preferably at least 30° C., more preferably at least 50° C., most preferably at least 100° C.; and forming the functionalised container from at least part of the heated container precursor; wherein the forming of the process step C) comprises a partial reshaping of the wall of glass of the at least part of the heated container precursor. Here, the partial reshaping of the wall of glass implies that a part of the wall of glass of the at least part of the heated container precursor is not reshaped. Preferably, a shape of this part of the wall of glass remains essentially unchanged. This part, preferably, constitutes a body region of the functionalised container

In an embodiment 2 of the process 2 according to the invention, the process 2 is designed according to its embodiment 1, wherein in the process step C) a first end region and a further end region, which is opposite the first end region, of the functionalised container are obtained by the partial reshaping.

In an embodiment 3 of the process 2 according to the invention, the process 2 is designed according to its embodiment 1 or 2, wherein in the functionalised container the wall of glass forms a hollow glass body which at least partially encloses an interior volume of the functionalised container, wherein the hollow glass body comprises in a direction of a length of the hollow glass body: a first end region, a body region, and a further end region, wherein at least a part of the wall of glass which constitutes the body region is not reshaped in the process step C).

In an embodiment 4 of the process 2 according to the invention, the process 2 is designed according to any of its embodiments 1 to 3, wherein the functionalised container is the container 1 or 2 of the invention, in each case according to any of its embodiments.

A contribution to solving at least one of the objects according to the invention is made by an embodiment 1 of a functionalised container obtainable by the process 2 of the invention according to any of its embodiments. In a preferred embodiment, the functionalised container has the features of the container 1 or 2 of the invention, in each case according to any of its embodiments.

A contribution to solving at least one of the objects according to the invention is made by an embodiment 1 of a closed container 1, comprising a wall of glass which forms a hollow glass body which at least partially encloses an interior volume of the closed container, the interior volume comprising a pharmaceutical composition; wherein the hollow glass body comprises in a direction of a length of the hollow glass body: a first end region, a body region, and a further end region; wherein the closed container meets one criterion, selected from the group consisting of A. to C. as set forth below: in the body region, on a side of the wall of glass which faces away from the interior volume the wall of glass is at least partially superimposed by a plurality of particles, and in the first end region, or in the further end region, or in each of both, in each case on the side of the wall of glass which faces away from the interior volume, the wall of glass is not superimposed by any part of the plurality of particles; in the body region a surface of the hollow glass body which faces away from the interior volume is at least partially characterised by a coefficient of dry sliding friction, in the first end region a surface of the hollow glass body which faces away from the interior volume is at least partially characterised by a first coefficient of static friction, in the further end region a surface of the hollow glass body which faces away from the interior volume is at least partially characterised by a further coefficient of static friction, a ratio of the coefficient of dry sliding friction to the first coefficient of static friction, or a ratio of the coefficient of dry sliding friction to the further coefficient of static friction, or each of both is in a range from 0.01 to 0.9, preferably from 0.01 to 0.5, more preferably from 0.01 to 0.1, and the first coefficient of static friction, or the further coefficient of static friction, or each of both is at least 0.15, preferably at least 0.16, more preferably at least 0.17, more preferably at least 0.18, more preferably at least 0.19, more preferably at least 0.20, more preferably at least 0.21, even more preferably at least 0.22, more preferably at least 0.23, most preferably more than 0.23; both of A. and B.

In a preferred embodiment of the closed container 1, it shows the technical features of the container 1 or 2 of the invention according to any of its embodiments, respectively.

A contribution to solving at least one of the objects according to the invention is made by an embodiment 1 of a process 3 comprising as process steps :provision of the container 1 according to any of its embodiments 1 to 25, or the container 2 according to any of its embodiments 1 to 14, or the functionalised container of the invention; inserting a pharmaceutical composition into the interior volume; and closing the container.

The closing in the process step c., preferably, comprises contacting the container with a closure, preferably a lid, preferably covering an opening of the container with the closure, and joining the closure to the container. The joining preferably comprises creating a form-fit of the container, preferably of the flange of the container, with the closure. The form-fit is preferably created via a crimping step. The process 3 is preferably a process for packaging the pharmaceutical composition.

In an embodiment 2 of the process 3 according to the invention, the process 3 is designed according to its embodiment 1, wherein after the process step a. and prior to the process step b. the process further comprises a step of heating the wall of glass at least partially to at least 200° C., preferably at least 250° C., more preferably at least 300° C., most preferably at least 320° C. The preceding temperature is preferably kept constant for a duration of at least 3 min, preferably at least 5 min, more preferably at least 10 min, even more preferably at least 30 min, most preferably at least 1 h. The preceding duration may be up to several days, preferably 48 h, more preferably 24 h. Particularly preferable, the heating is a measure of a depyrogenisation step.

A contribution to solving at least one of the objects according to the invention is made by an embodiment 1 of a closed container 2, obtainable by the process 3 according to any of its embodiments. In a preferred embodiment of the closed container 2, it shows the technical features of the closed container 1 of the invention according to any of its embodiments.

A contribution to solving at least one of the objects according to the invention is made by an embodiment 1 of a process 4, comprising as process steps: provision of the container 1 according to its embodiment 26, or the container 2 according to its embodiment 15, or the closed container 1 or 2, in each case according to any of its embodiments; and administering the pharmaceutical composition to a patient.

A contribution to solving at least one of the objects according to the invention is made by an embodiment 1 of a use 1of the container precursor 1 or 2, in each case according to any of its embodiments, or of the functionalised container precursor of the invention for making a packaging container for a medical or a pharmaceutical packaging good. In a preferred embodiment, the packaging container is the container 1 or 2 of the invention, in each case according to any of its embodiments.

A contribution to solving at least one of the objects according to the invention is made by an embodiment 1 of a use 2 of the container 1 according to any of its embodiments 1 to 25, or the container 2 according to any of its embodiments 1 to 14, or the functionalised container of the invention for packaging a pharmaceutical composition. The packaging preferably comprises inserting the pharmaceutical composition into the interior volume and closing the container or the functionalised container, respectively.

A contribution to solving at least one of the objects according to the invention is made by an embodiment 1 of a use 3 of a plurality of particles for adjusting a coefficient of dry sliding friction of a surface of a wall of glass of a container precursor to be less than 0.25, preferably less than 0.20, more preferably less than 0.18, more preferably less than 0.16, more preferably less than 0.15, more preferably less than 0.12, more preferably less than 0.10, more preferably less than 0.05, more preferably less than 0.03, most preferably less than 0.02, wherein the wall of glass at least partially encloses an interior volume of the container precursor, wherein the surface faces away from the interior volume.

In an embodiment 2 of the use 3 according to the invention, the use 3 is designed according to its embodiment 1, wherein the plurality of particles is characterised by particle size distribution having a D₅₀ in a range from 1 to 100 μm, preferably from 1 to 80 μm, more preferably from 1 to 60 μm, more preferably from 1 to 40 μm, more preferably from 1 to 20 μm, more preferably from 1 to 15 μm, even more preferably from 2 to 10 μm, most preferably from 2 to 6 μm. In a preferred embodiment, the D₅₀ of the particle size distribution is in an range from 2 to 100 μm, preferably from 2 to 80 μm, more preferably from 2 to 60 μm, more preferably from 2 to 40 μm, more preferably from 2 to 20 μm, more preferably from 2 to 15 μm, even more preferably from 2 to 10 μm, most preferably from 2 to 6 μm. In a further preferred embodiment, the particle size distribution of the plurality of particles, additionally, has a D₁₀ in an range from 0.1 to 50 μm, preferably from 0.5 to 10 μm, more preferably from 0.5 to 5 μm, most preferably from 1 to 3 μm; or a D₉₀ in an range from 0.5 to 100 μm, preferably from 0.5 to 50 μm, more preferably from 1 to 20 μm, most preferably from 2 to 10 μm; or both.

In an embodiment 3 of the use 3 according to the invention, the use 3 is designed according to its embodiment 1 or 2, wherein the plurality of particles is further used for adjusting a contact angle for wetting with water of the surface to be in a range from 0 to 45°, preferably from 5 to 45°, more preferably 10 to 45°.

Features described as preferred in one category of the invention, for example according to the container precursor 1 or 2, are analogously preferred in an embodiment of the other categories according to the invention.

### Container Precursor

Any kind of container precursor which the skilled person knows and which he deems suitable in the context of the invention comes into consideration as the container precursor of the invention. Generally, the container precursor is a precursor of a container which arises in the course of production of the container. Hence, the container precursor is, preferably, designed for producing at least one container, more preferably at least 2, even more preferably at least 10 containers, from the container precursor. The preceding container/containers is/are, preferably, packaging containers for a medical or a pharmaceutical packaging good or both. A particularly preferred container for a medical or a pharmaceutical packaging good or both is one selected from the group consisting of a vial, a syringe, a cartridge, and an ampoule; or a combination of at least two thereof. Further, in this context, a preferred container includes a hollow glass body which is formed from the wall of glass. In a preferred embodiment, the container precursor consists of the wall of glass. Hence, the container precursor is, preferably, a hollow glass body. The hollow glass body may be open or closed. In case of a closed hollow glass body, the interior volume of the container precursor is, preferably, enclosed by the wall of glass across at least 90%, preferably across at least 95%, most preferably at least 99%, of a surface area of the interior volume. The remainder to 100% which is not enclosed by the wall of glass, preferably, constitutes a hole which has been provided in the wall of glass for venting. Preferably, the hole for venting has a diameter in the range from 1 to 3 mm. Producing the at least one container from the container precursor, preferably, includes, more preferably consists of, partially reshaping the wall of glass of the container precursor. Herein, partially reshaping means that part of the wall of glass is not reshaped. Preferably that part is of the same shape in the container as in the container precursor from which the container has been produced. The part of the wall of glass which is preferably not reshaped in the production of the container from the container precursor, preferably, has the shape of a hollow cylinder. Further preferably, that part constitutes the body region of the container.

Generally, the container precursor of the invention can have any shape and design which the skilled person deems appropriate for production of a container from the container precursor. A particularly preferred container precursor comprises a tube. The tube is preferably formed from the wall of glass. Herein, a tube is, preferably, a cylinder. The end faces of the cylinder may have any shape which the skilled person deems appropriate. In particular, round end faces, such as circular or oval end faces, and angular end faces, such as rectangular, triangular and polygonal end faces, come into consideration. It is also conceivable that the end faces of the cylinder have different shapes. Further, the cylinder may be a right cylinder, an oblique cylinder or a bend cylinder. Therein, a bend cylinder has a curvature along its length. A particularly preferred cylinder is a right circular cylinder. Herein, the term tube refers to a hollow body which, as such, has open end faces. A preferred container precursor of the invention consists of a tube. In that case, the container precursor has open end faces. A further preferred container precursor of the invention comprises a tube and, in addition, one or two end face parts which each seal an end face of the tube. A container precursor which comprises a tube may or may not include further parts, in addition to the tube, such as one or two end face parts and also further parts. Here, the container precursor, preferably, comprises two end face parts, each of which seals one of the two end faces of the tube. A preferred end face part is formed from the wall of glass.

A particularly preferred container precursor of the invention is a semi-endless tube which has been drawn from a glass melt. That semi-endless tube often has a length of at least 10 m. Typically, that length does not exceed 100 m. Preferably, the semi-endless tube is open at both end faces.

A further particularly preferred container precursor of the invention is a tube which has been obtained by separating the preceding semi-endless tube into a multitude of shorter tubes. These tubes often have lengths of about 1.5 m. In this context, it is further preferred that the container precursor is sealed at one or both, of the end faces of the tube. Here, the tube which has been obtained by separation from the semi-endless tube has, preferably, further been sealed at one or both end faces by heating the wall of glass above the transformation temperature T_{g} of the glass of the wall of glass, preferably above the softening temperature of the glass of the wall of glass, at the respective end face and reshaping the wall of glass in order to seal that end face. In that case, the container precursor comprises the tube and one or two end face parts which seal the tube at the respective end face. Therein, the tube and the one or two end face parts are, preferably, formed from the wall of glass. Further preferably, after sealing, the above mentioned hole for venting is provided in the wall of glass. Producing a container from such container precursor, preferably, includes separating off the end regions of the container precursor, each including one of the end face parts, and partly reshaping the remaining tubular section of the container precursor into one or more, typically at least 10, containers. The term “partly reshaping” herein, preferably, means that each of the containers produced from the tubular section includes a part of the tubular section which is of essentially the same shape as in the container precursor. Each of these parts, preferably, is of the shape of a hollow cylinder.

### Container

The container according to the invention may have any size or shape which the skilled person deems appropriate in the context of the invention. A preferred container of the invention is obtainable from the container precursor of the invention described in the previous paragraph, preferably by the measures described in the previous paragraph.

The first end region of the container is preferably a top region. The further end region of the container is preferably a bottom region. The body region of the container, preferably, follows the top region, preferably via a shoulder, and the bottom region, preferably, follows the body region, preferably via a heel, in each case from top to bottom of the container. A preferred bottom region of the container is a standing base. The bottom region may be planar or concave, wherein a concave bottom region is preferred. Particularly preferable, the bottom region is not convex as a convex surface is not appropriate as a standing base. Preferably, the body region is a lateral region of the hollow body. Particularly preferable, the body region of the wall forms a hollow cylinder. The top region preferably comprises, more preferably consists of, a flange and a neck from top to bottom of the container. Preferably, on the side of the wall of glass which faces away from the interior volume the wall of glass is not superimposed by any part of the plurality of particles at the shoulder or at the heel or both. Preferably, at the shoulder or at the heel or both, in each case on the side of the wall of glass which faces away from the interior volume, the wall of glass is not superimposed by any particle which is joined to the wall of glass. Further preferably, the first and further end regions of the container of the invention are obtainable from the container precursor via the partial reshaping of the container precursor. The body region of the container, preferably, is a part of the container which is of essentially the same shape as in the container precursor from which the container has been produced. Preferably, the first or further end region of the container comprises an opening, which allows for inserting a pharmaceutical composition into the interior volume of the container. In that case, the hollow glass body encloses the interior volume of the container only partially. Preferably, the wall of glass is of a one-piece design. In a particularly preferred embodiment, the hollow glass body of the container of the invention has the shape of a bottle.

For the use in this document, the interior volume of the container is the full volume of the interior of the container. This volume may be determined by filling the interior of the container with water up to the brim and measuring the volume of the amount of water which the interior can take up to the brim. Hence, the interior volume as used herein in the context of the container is not a nominal volume as it is often referred to in the technical field of pharmacy. This nominal volume may for example be less than the interior volume of the container by a factor of about 0.5.

### Wall of Glass

The wall of glass of the container and container precursor of the invention may have any shape and design which the skilled person deems appropriate in the context of the invention. Generally, the wall of glass, preferably, forms a wall of a hollow glass body which at least partly encloses the interior volume. Preferably, the wall of glass comprises a weight majority of a glass, more preferably the wall of glass essentially consists of the glass. Further, the wall of glass may be superimposed by one or more additional layers, more preferably at a side of the wall of glass which faces the interior volume. Unless otherwise indicated, the components of the wall of the hollow glass body, in particular the wall of glass, the particles of the plurality of particles and any additional layer which superimposes the wall of glass, may follow one another in a direction of a thickness of the wall indirectly, in other words with one or more intermediate components, or directly, in other words without any intermediate component. This is particularly the case with the formulation wherein one component, for example particles, superimposes another, for example the wall of glass. Further, if a component is superimposed onto a layer or a surface, this component may be contacted with that layer or surface or it may not be contacted with that layer or surface, but be indirectly overlaid onto that layer or surface with another component (e.g. a layer) in-between. If, however, a component adjoins another, in particular if the plurality of particles adjoins the wall of glass, these components are in direct contact without any intermediate component in-between. In any case, the components of the wall of the hollow glass body, in particular the wall of glass, the particles of the plurality of particles and any additional layer which superimposes the wall of glass, are joined to one another. Two components are joined to one another when their adhesion to one another goes beyond Van-der-Waals attraction forces. The particles of the plurality of particles, however, may be joined to the wall of glass through Van-der-Waals attraction forces, or covalent bonds, or both. Preferably, the plurality of particles forms at least a part of the surface of the hollow glass body of the container precursor and/or the container of the invention. Preferably, the plurality of particles forms at least a part of a surface of the container precursor and/or the container which faces away from the interior volume.

### Glass

The glass of the wall of glass may be of any type of glass and any glass composition which the skilled person deems suitable in the context of the invention. Preferably, the glass is suitable for pharmaceutical packaging. Particularly preferable, the glass is of type I in accordance with the definitions of glass types in section 3.2.1 of the European Pharmacopoeia, 7^{th} edition from 2011. Additionally or alternatively preferable to the preceding, the glass is selected from the group consisting of a borosilicate glass, an aluminosilicate glass, and fused silica; or a combination of at least two thereof. For the use in this document, an aluminosilicate glass is a glass which has a content of Al₂O₃ of more than 8 wt.-%, preferably more than 9 wt.-%, particularly preferable in a range from 9 to 20 wt.-%, in each case based on the total weight of the glass. A preferred aluminosilicate glass has a content of B2O₃ of less than 8 wt.-%, preferably at maximum 7 wt.-%, particularly preferably in a range from 0 to 7 wt.-%, in each case based on the total weight of the glass. For the use in this document, a borosilicate glass is a glass which has a content of B₂O₃ of at least 1 wt.-%, preferably at least 2 wt.-%, more preferably at least 3 wt.-%, more preferably at least 4 wt.-%, even more preferably at least 5 wt.-%, particularly preferable in a range from 5 to 15 wt.-%, in each case based on the total weight of the glass. A preferred borosilicate glass has a content of A120₃ of less than 7.5 wt.-%, preferably less than 6.5 wt.-%, particularly preferably in a range from 0 to 5.5 wt.-%, in each case based on the total weight of the glass. In a further aspect, the borosilicate glass has a content of A120₃ in a range from 3 to 7.5 wt.-%, preferably in a range from 4 to 6 wt.-%, in each case based on the total weight of the glass.

A glass which is further preferred according to the invention is essentially free from B. Therein, the wording “essentially free from B” refers to glasses which are free from B which has been added to the glass composition by purpose. This means that B may still be present as an impurity, but preferably at a proportion of not more than 0.1 wt.-%, more preferably not more than 0.05 wt.-%, in each case based on the weight of the glass. In the art of glass making, the content of B of a glass is often provided based on B₂O₃, although the B does not necessarily have to be present in the glass in the form this particular oxide. Therefore, the preceding contents have been based on B, no matter in which particular chemical form it is present, be it in a compound, such as an oxide, or in elemental form or in a combination of different forms.

### Alkali Metal Barrier Layer and Hydrophobic Layer

In a preferred embodiment, the wall of glass of the container is superimposed by an alkali metal barrier layer or by a hydrophobic layer or both, in each case towards the interior volume of the container. Preferably, the alkali metal barrier layer or by the hydrophobic layer or both form at least a part of the interior surface, preferably the full interior surface. The alkali metal barrier layer may consist of any material or any combination of materials which the skilled person deems suitable for providing a barrier action against migration of an alkali metal ion, preferably against any alkali metal ion. The alkali metal barrier layer may be of a multilayer structure. Preferably, the alkali metal barrier layer comprises SiO₂, preferably a layer of SiO₂. Further, the hydrophobic layer may consist of any material or any combination of materials which provides a layer surface towards the interior volume which has a contact angle for wetting with water of more than 90° . The hydrophobic layer preferably allows for the formation of a well-defined cake upon freeze-drying, in particular in terms of a shape of the cake. A preferred hydrophobic layer comprises a compound of the general formula Si—OₓC_{y}H_{z}, preferably a layer of this compound. Therein, x is a number which is less than 1, preferably in a range from 0.6 to 0.9, more preferably from 0.7 to 0.8; y is a number in a range from 1.2 to 3.3, preferably from 1.5 to 2.5; and z is a number as well.

### Particle Size Distribution

The D₅₀ of a particle size distribution provides the particle diameter for which 50% of all particles of the plurality of particles having this particle size distribution have diameters smaller than this value. The D₁₀ of a particle size distribution provides the particle diameter for which 10% of all particles of the plurality of particles having this particle size distribution have diameters smaller than this value. The D₉₀ of a particle size distribution provides the particle diameter for which 90% of all particles of the plurality of particles having this particle size distribution have diameters smaller than this value. The D₁₀, D₅₀ and D₉₀ are further defined by the method of measurement of the particle size distribution as provided herein.

### Aspect Ratio

The aspect ratio is the quotient of the length of a particle divided its thickness. In Cartesian coordinates, the length of a particle lies on one axis, the width of the particle lies on another axis and the thickness on still another axis. Here, the length is more than the width which is more than the thickness of the particle.

### Dispersion

The composition of the process 1 according to the invention is preferably a dispersion. Generally, a dispersion is a system in which particles are dispersed in a continuous phase. There are three main types of dispersions: a coarse dispersion which is also referred to as suspension, a colloid, and a solution. A suspension is a heterogeneous mixture that contains solid particles sufficiently large for sedimentation. The particles may be visible to the naked eye, usually must be larger than 1 micrometre, and will eventually settle. A suspension is a heterogeneous mixture in which the dispersed particles do not dissolve, but get suspended throughout the bulk of the continuous phase, left floating around freely in the medium. The particles may be dispersed throughout the continuous phase through mechanical agitation, with the use of certain excipients or suspending or dispersing agents. The suspended particles are visible under a microscope and will settle over time if left undisturbed. This distinguishes a suspension from a colloid, in which the dispersed particles are smaller and do not settle. Colloids and suspensions are different from a solution, in which the particles do not exist as a solid, but are dissolved. The composition of the invention is preferably a dispersion in which solid particles, in particular the first plurality of particles, are dispersed in a liquid phase, referred to herein as vehicle. In the context of the composition of the invention, a preferred dispersion is a suspension.

### Vehicle

As the vehicle each vehicle which the skilled person knows and deems appropriate for being used in the context of the invention comes into consideration. Here, the vehicle is a, preferably liquid, medium which allows for the at least partial superposition of the first plurality of particles onto the wall of glass in a convenient, preferably uniform, manner. Preferably, the vehicle has a viscosity which is suitable for the preceding purpose. Further preferably, the vehicle has a rather high vapour pressure which allows for decreasing the proportion of the vehicle in the composition through evaporation of the vehicle in the process step c) at a temperature as close to 20° C. as possible. In a case in which the composition is a dispersion, the vehicle is preferably the continuous, preferably liquid, phase of the dispersion.

### Dispersing Agent

In the process step b) of the process 1 according to the invention, the composition preferably comprises one or more dispersing agents. Here, any dispersing agent which the skilled person knows and which he deems appropriate to be utilised in the context of the invention comes into consideration. Preferably, the dispersing agent supports keeping the particles of the first plurality of particles dispersed throughout the vehicle as homogenously as possible. A preferred dispersing agent is one selected from the group consisting of a polyacrylic acid, a polyimine, para-toluolsulfonic acid, a polyvinylpyrrolidone, a polyethylenglycol, hydroxypropylcellulose, an additive for inkjet inks, and a wetting or dispersing additive from the DISPERBYK series which is commercially available from BYK-Chemie GmbH, Wesel, Germany; or a combination of at least two thereof. Therein, a polyacrylic acid is a particularly preferred dispersing agent if the composition has a pH of more than 7. Further, a polyimine is a particularly preferred dispersing agent if the composition has a pH of less than 7. A preferred additive for inkjet inks is an additive of the BYKJET series which is commercially available from BYK-Chemie GmbH, Wesel, Germany. In a case in which the particles of the first plurality of particles comprise, preferably consist of, PDMS an alternatively or additionally preferred dispersing agent is selected from the group consisting of a silicon oligomer with short chains, a stearate, and a laurate, or from a combination of at least two thereof. A preferred silicon oligomer with short chains has a viscosity in a range from 5·10⁻⁴ to 100·10⁻⁴ m²/s.

### Polyalkylsiloxanes

In the context of the invention, any polyalkylsiloxane which the skilled person knows and deems appropriate for any of the purposes of the invention comes into consideration for the particles of the plurality of particles of the container precursors and the containers 1 and 2 according to the invention, and for the first and further plurality of particles of the process 1 according to the invention, as well as for the plurality of particles of the use 3 according to the invention. A preferred polyalkylsiloxane is a polymethylsiloxane. A preferred polymethylsiloxane is a polydimethylsiloxane (PDMS).

### Depyrogenisation

Particularly preferable, the heating after the process step a. and prior the process step b. of the process 3 is a measure of a depyrogenisation step. In the technical field of pharmacy, depyrogenisation is a step of decreasing an amount of pyrogenic germs on a surface, preferably via a heat-treatment. Therein, the amount of pyrogenic germs on the surface is preferably decreased as much as possible, preferably by at least 80%, more preferably at least 90%, more preferably at least 95%, even more preferably at least 99%, even more preferably at least 99.5%, most preferably by 100%, in each case based on an amount of the pyrogenic germs on the surface prior to the depyrogenisation.

### Pharmaceutical Composition

In the context of the invention, every pharmaceutical composition which the skilled person deems suitable comes into consideration. A pharmaceutical composition is a composition comprising at least one active ingredient. A preferred active ingredient is a vaccine. The pharmaceutical composition may be fluid or solid or both, wherein a fluid composition is particularly preferred herein. A preferred solid composition is granular such as a powder, a multitude of tablets or a multitude of capsules. A further preferred pharmaceutical composition is a parenterialium, i.e. a composition which is intended to be administered via the parenteral route, which may be any route which is not enteral. Parenteral administration can be performed by injection, e.g. using a needle (usually a hypodermic needle) and a syringe, or by the insertion of an indwelling catheter.

### Measurement Methods

The following measurement methods are to be used in the context of the invention. Unless otherwise specified, the measurements have to be carried out at an ambient temperature of 23° C., an ambient air pressure of 100 kPa (0.986 atm) and a relative atmospheric humidity of 50%.

Contact Angle for Wetting with Water

The contact angle of a surface for wetting with water is determined in accordance with the standard DIN 55660, parts 1 and 2. The contact angle is determined using the static method. Deviating from the standard, the measurement is conducted at curved surfaces as the walls of the container precursor and the container are usually curved. Further, the measurements are conducted at 22 to 25° C. ambient temperature and 20 to 35% relative atmospheric humidity. A Drop Shape Analyzer—DSA3OS from Krüss GmbH is applied for the measurements. Uncertainty of the measurement increases for contact angles below 10°.

### Wall Thickness and Tolerance of Wall Thickness

The wall thickness and deviations from the mean value of the wall thickness (tolerance) are determined in accordance with the following standards for the respective type of container: DIN ISO 8362-1 for vials, DIN ISO 9187-1 for ampoules, DIN ISO 110 4 0-4 for syringes, DIN ISO 13926-1 for cylindrical cartridges, and DIN ISO 11040-1 for dental cartridges.

### Softening Temperature

The softening temperature of a glass is defined as the temperature of the glass at which the glass has a viscosity η in dPa·s (=Poise) such that log₁₀(η)=7.6. The softening temperature is determined in accordance with ISO 7884-3.

### Transformation Temperature T_{g}

The transformation temperature is determined in accordance with ISO 7884-8.

### Transmission Coefficient

Herein, the transmission coefficients are defined as T=Iₜᵣₐₙₛ/I₀, wherein I₀ is the intensity of the light which is incident at a right angle on an incidence region of the surface region and Iₜᵣₐₙₛ is the intensity of the light which leaves the container precursor or the container, respectively, on a side which is opposite to the incidence region. Hence, T refers to light which transmits the empty container precursor/the container completely, i.e. one time through the wall into the empty interior volume and from there a second time through the wall out of the interior volume. Hence, the light transmits through two curved sections of the wall of the container precursor/the container. The transmission coefficient is determined in accordance with the standard ISO 15368:2001(E), wherein an area of measurement of the dimensions 3 mm×4 mm is used. Further, the light is incident on the container precursor/the container at a right angle to the vertical extension and through a central axis of the container precursor/the container. Preferably, the transmission coefficients of containers herein refer to a container of the type 2R according to DIN/ISO 8362 and/or to a transmission of the light through a part of the container precursor/the container which is of the shape of a hollow cylinder.

### Haze

The haze is a measure for the light scattering properties of a transparent sample, such as a glass sample. The value of the haze represents the fraction of light which has been transmitted through the sample, here the container precursor or empty container, and which is scattered out of a certain spatial angle around the optical axis. Thus, the haze quantifies material defects in the sample which negatively affect transparency. Herein, the haze is determined according to the standard ASTM D 1033. In accordance with this standard, 4 spectra are measured and for each of them the transmission coefficient is calculated. The haze value in % is calculated from these coefficients of transmission. A Thermo Scientific Evolution 600 spectrometer with integrating sphere and the software OptLab-SPX are applied for the measurements. In order to allow for measuring the diffusive transmission, the sample is positioned in front of the entrance of the integrating sphere. The reflection opening is left empty such that only the transmitted and scattered fraction of the incident light is detected. The fraction of the transmitted light which is not sufficiently scattered is not detected. Further measurements pertain to detection of the scattered light in the sphere (without sample) and to the overall transmission of the sample (reflection opening closed). All the measurement results are normalised to the overall transmission of the sphere without sample which is implemented as obligatory baseline correction in the software. Herein, the haze refers to light which transmits the container precursor/the container completely, i.e. one time through the wall into the interior volume and from there a second time through the wall out of the interior volume. Hence, the light transmits through two curved sections of the wall of the container precursor/the container. Further, the light is incident on the container precursor/the container at a right angle to the vertical extension and through a central axis of the container precursor/the container. The container, preferably, is a vial of the type 2R according to DIN/ISO 8362 and/or the transmission is conducted through a part of the container precursor/the container which is of the shape of a hollow cylinder.

### Scratch Test and Coefficient of Dry Sliding Friction

An MCT MikroCombiTester (MCT S/N 01-04488) from CSM Instruments is applied for the scratch test and for measuring the coefficient of dry friction. As the friction partner, a container precursor/the container which is identical to the container precursor/the container to be tested, including any coatings or functionalisations, is used. Further, in the test same surfaces are scratched/slid against each other. The friction partner is hold in position by a special mount above the container precursor/the container to be tested. Here, the friction partner and the container pre-cursor/the container to be tested incline an angle of 90° in a top view. For both measurements, the specimen to be tested is moved forwards, thereby scratching over the surface of the friction partner at a well-defined normal force (test force). For both tests, the specimen to be measured is moved forwards underneath the friction partner at a velocity of 10 mm/min over a test length of 15 mm. In case of the scratch test, the test force is progressively increased from 0 to 30 N (load rate 19.99 N/min) across the test length. Afterwards, the scratched surface is checked with a microscope at a magnification of 5 times. In case of measuring the coefficient of dry sliding friction, a constant normal force of 0.5 N is applied. The lateral friction force is measured using the friction measuring table. The coefficient of dry sliding friction is determined from the measured curves as the ratio of friction force to normal force (test force), wherein only values after the initial 0.2 mm up to the full test length of 15 mm are considered, in order to minimise the influence of the static friction.

### Coefficient of Static Friction

The coefficient of static friction is determined at an inclined plane. The specimen is placed with the surface to be tested onto a SCHOTT Nextrema® ceramic glass plate which is commercially available from Schott AG. Further, a 75 g-weight is placed on top of the specimen with a piece of leather in-between. The angle of inclination of the ceramic glass plate is increased slowly until the specimen starts to slide down the inclined plane. The angle at which the sliding starts is measured. The coefficient of static friction is determined as the tangent of this angle (tan α).

### Cover Ratio

Here, a topographical measurement of the surface to be studied is conducted with a white-light-spectrometer of the type Coherence Scanning Interferometry/Phase Shift Interferometry (CSI/PSI) from Zygo Corporation. The cover ratio is calculated from the obtained topographical image. The sum of the particles is divided by the total area of measurement.

### Particle Size Distribution

The particle size distribution is determined by dynamic light scattering (DLS). A Delsa™ Nano HC from Beckman Coulter is applied for the measurement. A sample of about 1 ml of the particles to be studied is taken. The sample is inserted into a plastic cuvette together with a liquid medium which is suitable for obtaining a dispersion. Therein, the liquid medium is to be chosen depending on the specific particles to be studied. In particular, the liquid medium is to be chosen such that a stable dispersion can be obtained in which the particles are visible for the measurement. In the case of the polymethylsiloxane particles (Tospearls 145A from Momentive Performance Materials Inc.) used in the examples below, n-butanol is to be used as the liquid medium. If the sample is a dispersion which is very opaque, it is diluted until the laser intensity is above 10%. The sample is measured in accordance with the standard method of the measurement device as 25° C. Therein, the algorithm calculates the diameter from 850 measurements. The standard software of the measuring device creates a diagram which shows the relative intensity of the measurements versus the particle diameter. The respective arithmetic mean and the standard deviation are provided by the software as well.

### Aspect Ratio

The aspect ratio of the particles is determined using an optical microscope or a scanning electron microscope. In each case, lengths and thicknesses of 10 arbitrarily chosen particles of the plurality of particles to be studied are measured and the arithmetic mean value is determined.

### Decomposition Temperature

Herein, the decomposition temperature of the particles of a plurality of particles is determined by taking a picture of a sample of the particles under a scanning electron microscope (SEM) at a suitable magnification as reference. Then, this sample is heated in an oven to the test temperature, kept at that test temperature for 1 hour and then cooled down again passively. Afterwards, the sample is examined under the SEM again at the same magnification. If particles can still be identified in the sample, the particles at least partially have a decomposition temperature which is above the test temperature. Therein, the particles may have shrunken in diameter in comparison to prior to the heat treatment. In that case, not all parts of the particles have a decomposition temperature above the test temperature, but still the particles at least partially have a decomposition temperature which is above the test temperature.

The invention is set out in more detail below by means of examples and drawings, with the examples and drawings not denoting any restriction on the invention. Furthermore, unless otherwise indicated, the drawings are not to scale.

### Washing Procedure

A HAMO LS 2000 washing machine is applied for the washing procedure. The HAMO LS 2000 is connected to the purified water supply. Further, the following devices are used.
cage 1: 144 with 4 mm nozzles
cage 2: 252 with 4 mm nozzles
drying cabinet from Heraeus (adjustable up to 300° C.)

The tap is opened. Then the machine is started via the main switch. After conducting an internal check, the washing machine shows to be ready on the display. Program 47 is a standard cleaning-program which operates with the following parameters:
pre-washing without heating for 2 min
   washing at 40° C. for 6 min
   pre-rinsing without heating for 5 min
   rinsing without heating for 10 min
   end-rinsing at without heating for 10 min
   drying without heating for 5 min

The holder in the cages 1 and 2 have to be adjusted considering the size of the tubes/vials in order to obtain a distance of the nozzle of about 1.5 cm. The tubes/vials to be washed are placed on the nozzles, in case of vials with the heads first. Subsequently, the stainless steel mesh is fixed on the cage. The cage is oriented to the left and pushed into the machine. Then the machine is closed. Program 47 (GLAS040102) is selected and then the HAMO is started via START. After the program has finished (1 h), the cages are taken out and the tubes/vials are placed in drying cages, in case of vials with their openings facing downwards. A convection drying cabinet with ambient air filter is applied for the drying. The drying cabinet is adjusted to 300° C. The tubes/vials are placed into the drying cabinet for 20 min. After the tubes/vials have cooled down, they are sorted into appropriate boxes.

### Preparation of Compositions

Composition 1: 5000 g of isopropanol are provided in a beaker. 300 g of tetraethoxysilane are added to the beaker and the obtained composition is stirred for 320 s with a magnetic stirrer at ambient temperature of 20° C. Further, 320 g of polysilsesquioxane particles (Tospearls 145A from Momentive Performance Materials Inc.) are added. The composition is stirred for another 4 h at the ambient temperature. The thus obtained suspension is ready for use.

Composition 2: 5000 g of high purity water are provided in a beaker. 300 g of tetraethoxysilane are added to the beaker and the obtained composition is stirred for 60 s with a magnetic stirrer at ambient temperature of 20° C. Subsequently, 1000 g of a polydimethylsiloxane (viscosity of 50.10⁻⁷ m²/s) are added while the composition is stirred. Then, the composition is heated to 30° C. Further, 320 g of polysilsesquioxane particles (Tospearls 145A from Momentive Performance Materials Inc.) are added. The composition is stirred for another 4 h at 30° C. The thus obtained suspension is ready for use.

Composition 3: 5000 g of high purity water are provided in a beaker. 300 g of tetraethoxysilane are added to the beaker and the obtained composition is stirred for 60 s with a magnetic stirrer at ambient temperature of 20° C. Subsequently, 1000 g of a polydimethylsiloxane (viscosity of 50·10⁻⁴ m²/s) are added while the composition is stirred. Then, the composition is heated to 30° C. Further, 320 g of polysilsesquioxane particles (Tospearls 145A from Momentive Performance Materials Inc.) and 50 g of the dispersing agent DISPERBYK-103 which is available from BYK-Chemie GmbH, Wesel, Germany are added. The composition is stirred for another 4 h at 30° C. The thus obtained suspension is ready for use.

### EXAMPLE 1

A commercially available glass tube of the type “Fiolax clear” from Schott AG is provided. The surface of this tube does not have any coating or functionalisation. This tube is washed as described above. The venting hole of the tube is closed by applying a small patch of adhesive tape. The washed tube is immersed into the composition 1, which has been prepared as set out above, and drawn through the composition at a velocity of 5 cm/min. As the tube is sealed at both ends, its inner surface is not contaminated thereby. Afterwards, the tube is withdrawn from the composition. The patch of adhesive tape is removed. Subsequently, the tube is placed in an oven where the tube is dried by keeping it at a temperature of 600° C. for 120 s. Afterwards, the tube is passively cooled to room temperature of 20° C.

### EXAMPLE 2

A commercially available glass tube of the type “Fiolax clear” from Schott AG is provided. The surface of this tube does not have any coating or functionalisation. This tube is washed as described above. The venting hole of the tube is closed by applying a small patch of adhesive tape. The washed tube is immersed into the composition 2, which has been prepared as set out above, and drawn through the composition at a velocity of 5 cm/min. As the tube is sealed at both ends, its inner surface is not contaminated thereby. Afterwards, the tube is withdrawn from the composition. The patch of adhesive tape is removed. Subsequently, the tube is placed in an oven where the tube is dried by keeping it at a temperature of 600° C. for 120 s. Afterwards, the tube is passively cooled to room temperature of 20° C.

### EXAMPLE 3

A commercially available glass tube of the type “Fiolax clear” from Schott AG is provided. The surface of this tube does not have any coating or functionalisation. This tube is washed as described above. The venting hole of the tube is closed by applying a small patch of adhesive tape. The composition 3, which has been prepared as set out above, is sprayed onto the washed tube homogeneously. As the tube is sealed at both ends, its inner surface is not contaminated thereby. The patch of adhesive tape is removed. Subsequently, the tube is placed in an oven where the tube is dried by keeping it at a temperature of 600° C. for 120 s. Afterwards, the tube is passively cooled to room temperature of 20° C.

### EXAMPLE 4

Example 4 is conducted as example 3, wherein the tube, onto which the composition 1 has been sprayed, is dried at ambient temperature of 20° C.

### EXAMPLE 5

A glass tube of length 10 m is prepared via a Danner process as described in detail in “Schott Guide to Glass”, Heinz G. Pfaender (Ed.), 2^{nd} Edition, Chapman and Hall, London, 1996, pages 93f, ISBN: 0412719606. This semi-endless glass tube is a precursor of the “Fiolax clear”-glass tube from Schott AG. Hence, it is made from glass of the same composition. Directly after the drawing process, the fresh outer glass surface of the still hot (400 to 500° C.) glass tube is sprayed homogeneously with composition 1. Afterwards, the tube is passively cooled to room temperature of 20° C.

### Evaluation of Glass Tubes as Container Precursors

For each of the examples 1 to 5, the contact angle for wetting with water and the coefficient of dry sliding friction are determined on the lateral exterior surfaces of the tubes which have been functionalised as described above. For comparison, the preceding parameters are also measured at a glass tube of the type “Fiolax clear” from Schott AG, which has been washed, but not functionalised or coated prior to the measurements. Further, scratch tests as described above are conducted on the functionalised tubes of the examples 1 to 5 and on the washed reference tubes without functionalisation. The results are shown in Table 1. Here, +means that in the scratch tests, the corresponding tubes are less prone to be scratched than tubes which have been assessed with −. In particular, the tubes according to the examples 1 to 5 show an improvement of their scratch resistance with respect to the reference tube at least up to test forces of 5 N.

TABLE 1
Characterisation of the exterior surfaces of the functionalised
glass tubes of the examples 1 to 5 and of a glass tube which
has been washed but not functionalised as reference

| | Contact angle | Coefficient of dry | |
|---|---|---|---|
| | for water | sliding friction of | Scratch |
| Example | [°] | exterior tube surface | resistance |
| Example 1 | 30 | 0.01 | + |
| Example 2 | 30 | 0.15 | + |
| Example 3 | 32 | 0.18 | + |
| Example 4 | 30 | 0.02 | + |
| Example 5 | 30 | 0.01 | + |
| Glass tube | <10 | 0.56 | − |
| “Fiolax clear” | | | |
| from Schott AG | | | |

Further, the transmission coefficients and the haze values of the functionalised tubes of the examples 1 to 5 and of a glass tube which has been washed but not functionalised have been measured as described above in the measurement methods section. It has been found that the transmission coefficients are all the same for the functionalised tubes of the examples 1 to 5 and for the reference glass tube without functionalisation. Further, it has been found that the haze of the functionalised tubes of the examples 1 to 5 is not more than 0.3% above the haze of the unfunctionalised reference tube.

Preparation of Vials from Functionalised Tubes of Examples 1 to 5

Glass vials of the type “Vial 2.00 ml Fiolax clear” from Schott AG are prepared from the functionalised tubes of the examples 1 to 5 as container precursors. In case of the example 5, the 10 m long glass tube is first cut into multiple glass tubes of the same length as the “Fiolax clear”-glass tubes of the examples 1 to 4. In case of the examples 1 to 4, the sealed ends of the tubes are cut off and discarded. Then multiple vials are produced from each tube of the examples 1 to 4, which has been prepared this way, and from each shortened tube of the example 5, in each case via a standard hot forming process. The top and bottom regions of each vial are formed by heating and reshaping corresponding regions of the functionalised tube. As these corresponding regions of the functionalised tube are heated to temperatures above 1,200° C., the particles which the glass tube has been functionalised with are molten into the glass wall in these regions. Accordingly, the vial does not show any functionalisation in its top region, shoulder, heel and bottom region. The body region of the vial, however, is constituted by a part of the functionalised glass tube which is not reshaped in the heat forming process. Therefore, the vials of the examples 1 to 5 have body regions which still show the functionalisation that has been applied to the glass tubes used as container precursors.

### COMPARATIVE EXAMPLE 1

A commercially available glass vial of the type “Vial 2.00 ml Fiolax clear” from Schott AG, which is further of the type 2R according to DIN/ISO 8362, is provided. The surface of this vial does not have any coating or functionalisation. This vial is washed as described above. The washed vial is immersed with its bottom first into the composition 1, which has been prepared as set out above, at a velocity of 30 cm/min. Therein, the head region of the vial, including the vial opening, is not immersed into the composition in order to prevent contacting the interior surface of the vial with the composition. The vial is kept in the composition for about 10 s. Afterwards, the vial is retracted from the composition at a velocity of 5 cm/min. Subsequently, the vial is kept as it is for 10 s at ambient temperature of 20° C. Then the vial is placed with its bottom onto an absorbent substrate such as a paper towel. Then the composition which has been applied to the vial is dried by keeping the vial for 30 min at a temperature of 600° C. in an oven. Afterwards, the vial is passively cooled to room temperature of 20° C.

### COMPARATIVE EXAMPLE 2

A commercially available glass vial of the type “Vial 2.00 ml Fiolax clear” from Schott AG, which is further of the type 2R according to DIN/ISO 8362, is provided. The surface of this vial does not have any coating or functionalisation. This vial is washed as described above. The washed vial is immersed with its bottom first into the composition 2, which has been prepared as set out above, at a velocity of 30 cm/min. Therein, the head region of the vial, including the vial opening, is not immersed into the composition in order to prevent contacting the interior surface of the vial with the composition. The vial is kept in the composition for about 10 s. Afterwards, the vial is retracted from the composition at a velocity of 5 cm/min. Subsequently, the vial is kept as it is for 10 s at ambient temperature of 20° C. Then the vial is placed with its bottom onto an absorbent substrate such as a paper towel. Then the composition which has been applied to the vial is dried by keeping the vial for 10 min at a temperature of 350° C. in an oven. Afterwards, the vial is passively cooled to room temperature of 20° C.

### COMPARATIVE EXAMPLE 3

A commercially available glass vial of the type “Vial 2.00 ml Fiolax clear” from Schott AG, which is further of the type 2R according to DIN/ISO 8362, is provided. The surface of this vial does not have any coating or functionalisation. This vial is washed as described above. The washed vial is immersed with its bottom first into the composition 3, which has been prepared as set out above, at a velocity of 30 cm/min. Therein, the head region of the vial, including the vial opening, is not immersed into the composition in order to prevent contacting the interior surface of the vial with the composition. The vial is kept in the composition for about 10 s. Afterwards, the vial is retracted from the composition at a velocity of 5 cm/min. Subsequently, the vial is kept as it is for 10 s at ambient temperature of 20° C. Then the vial is placed with its bottom onto an absorbent substrate such as a paper towel. Then the composition which has been applied to the vial is dried by keeping the vial for 10 min at a temperature of 350° C. in an oven. Afterwards, the vial is passively cooled to room temperature of 20° C.

### COMPARATIVE EXAMPLE 4

A commercially available glass vial of the type “Vial 2.00 ml Fiolax clear” from Schott AG, which of the type 2R according to DIN/ISO 8362, is provided as a reference. The surface of this vial does not have any coating or functionalisation.

### COMPARATIVE EXAMPLE 5

A commercially available glass vial of the type “Vial 2.00 ml Fiolax clear” from Schott AG, which of the type 2R according to DIN/ISO 8362, is coated on its exterior surface with MED10-6670 from NuSiL.

### COMPARATIVE EXAMPLE 6

A commercially available glass vial of the type “Vial 2.00 ml Fiolax clear” from Schott AG, which is further of the type 2R according to DIN/ISO 8362, is provided. The surface of this vial does not have any coating or functionalisation. This vial is washed as described above. Then the vial is placed inside a SCS Labcoater®, Model PDS 2010. Via a vacuum process, the vial is first functionalised with 3-methacrylaoxypropyltrimethoxysilane by evaporation without further heat treatment and then coated with Parylen C by evaporation at 100° C. The final coating has a film thickness of 250 nm.

### COMPARATIVE EXAMPLE 7

Preparation of the composition: 99.8 ml of high purity water are provided in a beaker. 0.2 ml of Levasil CS50-34P (50% SiO₂, average particle size less than 100 nm) from Akzo Nobel N.V. are added to the beaker and the obtained composition is stirred for 30 s with a magnetic stirrer at ambient temperature of 20° C. Subsequently, 0.5 ml g of Tween20 from Sigma Aldrich are added. Then, the composition is stirred for another 10 min. The thus obtained composition is ready for use.

Functionalisation with the Composition:

A commercially available glass vial of the type “Vial 2.00 ml Fiolax clear” from Schott AG, which is further of the type 2R according to DIN/ISO 8362, is provided. The surface of this vial does not have any coating or functionalisation. This vial is washed as described above. The washed vial is immersed with its bottom first into the composition, which has been prepared as set out above, at a velocity of 30 cm/min. Therein, the head region of the vial, including the vial opening, is not immersed into the composition in order to prevent contacting the interior surface of the vial with the composition. The vial is kept in the composition for 2 s. Afterwards, the vial is retracted from the composition at a velocity of 20 cm/min. Subsequently, the vial is kept as it is for 10 s at ambient temperature of 20° C. Then the vial is placed with its bottom onto an absorbent substrate such as a paper towel. Then the composition which has been applied to the vial is dried by keeping the vial for 30 min at a temperature of 600° C. in an oven.

### Evaluation of Containers

Further, each of the examples 1 to 5 and the comparative examples 1 to 7, the contact angle for wetting with water and the coefficient of dry sliding friction are determined on the exterior surface of the vial body region (hollow cylindrical part) in accordance with the above measurement methods, respectively. Further, the coefficient of static friction is measured on the exterior surface of the bottom (standing base) of the vials. The results are shown in Table 2.

TABLE 2
Characterisation of the exterior surfaces of the glass vials of the
examples and comparative examples by their contact angles for wetting
with water and coefficients of dry sliding friction (body region) and
static friction (bottom), in each case prior to any post treatment

| | Contact angle | Coefficient of dry | Coefficient of |
|---|---|---|---|
| | for water | sliding friction of | static friction of |
| Example | [°] | container body region | container bottom |
| Example 1 | 30 | 0.01 | 0.24 |
| Example 2 | 30 | 0.15 | 0.25 |
| Example 3 | 32 | 0.18 | 0.22 |
| Example 4 | 30 | 0.02 | 0.26 |
| Example 5 | 30 | 0.01 | 0.22 |
| Comparative | 34 | 0.01 | 0.14 |
| example 1 | | | |
| Comparative | 26 | 0.18 | 0.15 |
| example 2 | | | |
| Comparative | 43 | 0.20 | 0.16 |
| example 3 | | | |
| Comparative | <10 | 0.56 | 0.24 |
| example 4 | | | |
| Comparative | 70 | 0.28 | 0.20 |
| example 5 | | | |
| Comparative | 93 | 0.45 | 0.24 |
| example 6 | | | |
| Comparative | <10 | 0.41 | 0.28 |
| example 7 | | | |

Further, 10,000 of the vials of each example and comparative example, respectively, are processed on a standard pharmaceutical filling line and thus, filled with an influenza vaccine. Table 3 below shows an evaluation of the vials regarding their tendency to be damaged on the filling line. Here, damages refer to scratches which the vials suffer or even glass breakage. The latter can, in particular, occur of vials bump into each other and thereby, one of the collision partners is accelerated such that it is tipped over. Further, breakage can occur by vials rubbing against each other, which can lead to a vial being lifted and tipped over. In Table 3, ++ indicates a more favourable result than+, which indicates a more favourable result than 0, which indicates a more favourable result than−.

TABLE 3
Comparison of the tendency of the glass vials to be damaged
on the filling line for the examples and comparative examples

| Example | Low tendency to damages on filling line |
|---|---|
| Example 1 | ++ |
| Example 2 | + |
| Example 3 | + |
| Example 4 | ++ |
| Example 5 | ++ |
| Comparative example 1 | 0 |
| Comparative example 2 | 0 |
| Comparative example 3 | 0 |
| Comparative example 4 | — |
| Comparative example 5 | — |
| Comparative example 6 | — |
| Comparative example 7 | — |

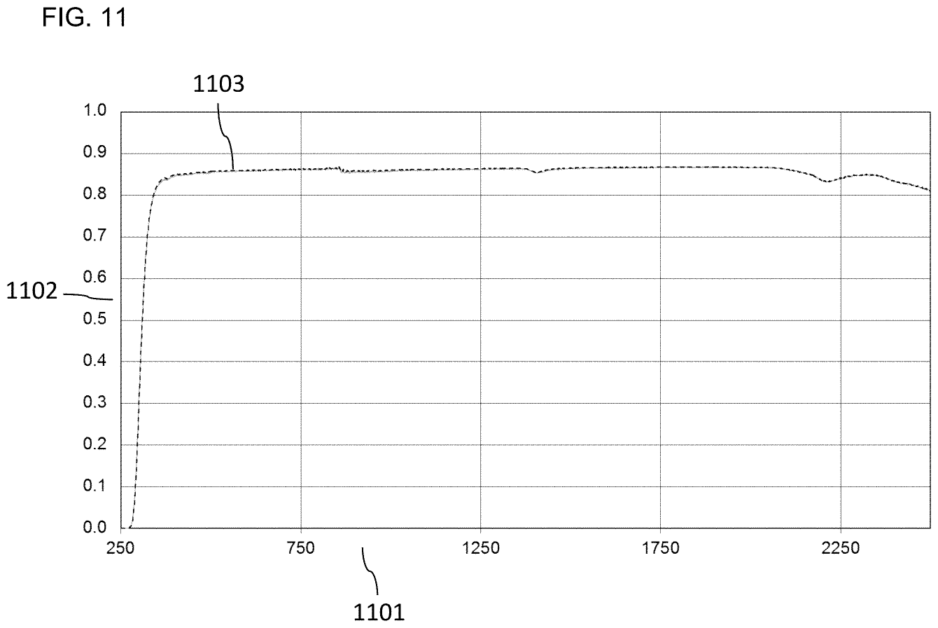

Further, the vials of the examples 1 to 5 and of the comparative example 4 are studied for their optical characteristics which may influence an optical inspection of the vials, in particular for pharmaceutically relevant particles, after being filled with a vaccine and being closed. These studies are conducted prior to filling the vials. Here, the increase of the haze by the functionalisation of the examples 1 to 5 is determined in accordance with the above measurement method to be less than 0.3% of the haze of an unfunctionalised reference vial of comparative example 4. Further, the transmission coefficients of vials of the examples 1 to 5 and of a reference vial of comparative example 4 are determined in accordance with the above measurement method. FIG. 11 shows the transmission coefficients of empty vials of the examples 1 to 5 and of comparative example 4 across a broad spectral range. From this figure, it can clearly be seen that the functionalisations according to the examples 1 to 5 do not significantly deteriorate the transmission coefficient in the studied spectral range.

For further studies, functionalised surfaces of vials according to the examples 1 to 5 and the comparative example 4 have been subjected to a scratch test which is described in detail in the above measurement methods sections. It has been shown that the vials according to the examples 1 to 5 show an improvement of their scratch resistance with respect to the reference vial of comparative example 4 at least up to test forces of 5 N.

### Post-Treatment

For further studies, the vials of the example 1 and of the comparative example 4 as reference are subjected to two different kinds of post-treatment, i.e. a depyrogenisation procedure and freeze drying. These kinds of post-treatment are described below.

### Depyrogenisation:

The vials are depyrogenised by placing them in an oven which is heated to 350° C. This temperature is kept constant for 1 h. Subsequently, the vials are taken out of the oven and left to cool down.

### Freeze Drying:

The vials are freeze dried by storing them for 4 hours at −70° C.

Evaluation after Post-Treatment

Vials of the examples 1 and 2 and of the comparative example 4 have been washed and then subjected to either depyrogenisation or freeze drying, respectively.

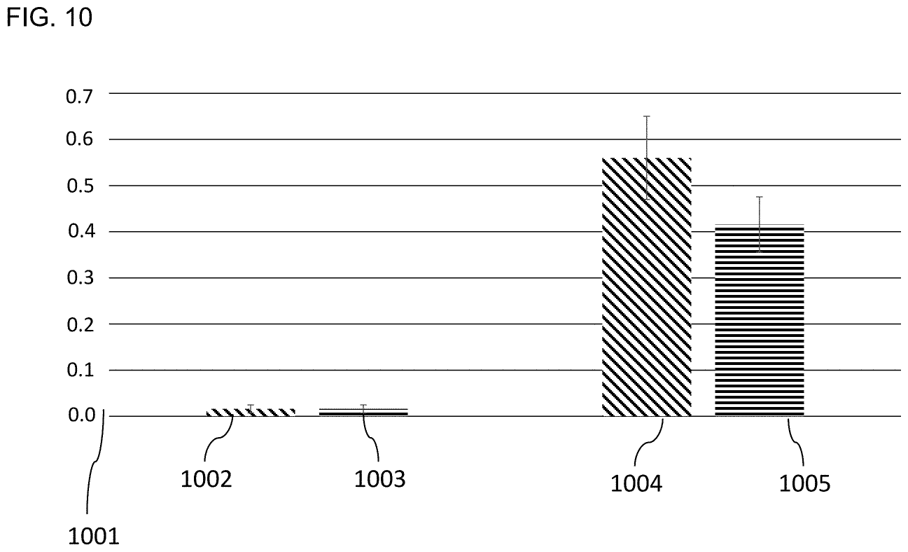

The coefficient of dry sliding friction of vials of the example 1 and comparative example 4 has been determined on the exterior surfaces of the vials in their tubular body regions after washing as well as after depyrogenisation. The results are shown in FIG. 10. It is demonstrated that the functionalisation of example 1 withstands the washing and depyrogenisation procedures.

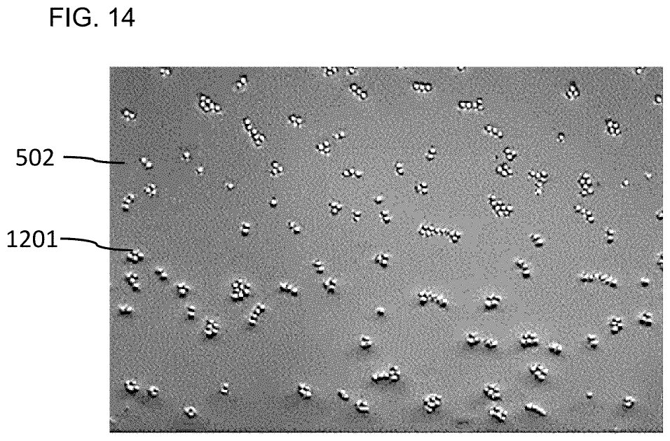

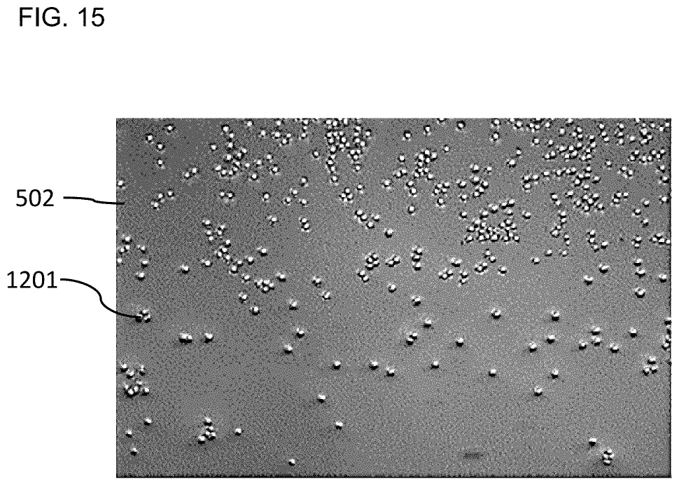

Further, vials of the example 2 have been studied for damages and defects caused by freeze drying under an optical microscope at a magnification of 5 to 20 times. It has been observed that no defects or damages have been caused by the freeze drying procedure. FIG. 14 shows the exterior surface of a vial of example 2 prior to freeze drying and FIG. 15 after freeze drying. No damages or defects are to bee seen.

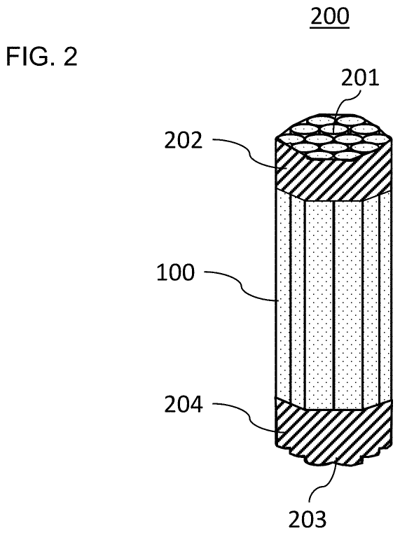

FIG. 2 shows a schematic depiction of an arrangement 200 according to the invention. The arrangement 200 comprises a packaging and a multitude of container precursors 100 of FIG. 1. The multitude of container precursors 100 is packaged in the packaging. Here, the container precursors 100 form a bundle of hexagonally packed container precursors 100. The bundle comprises a first longitudinal end 201, which is wrapped in a first envelope 202, and a further longitudinal end 203, which is wrapped in a further envelope 204. The first 202 and further envelopes 204 form the packaging. Further the first 202 and further envelopes 204 are shrink foils. In the arrangement 200 of FIG. 2, the container precursors 100 are packed in contact with one another. The shrink foils prevent the container precursors 100 from moving relative to each other and thus, from scratching against each other.

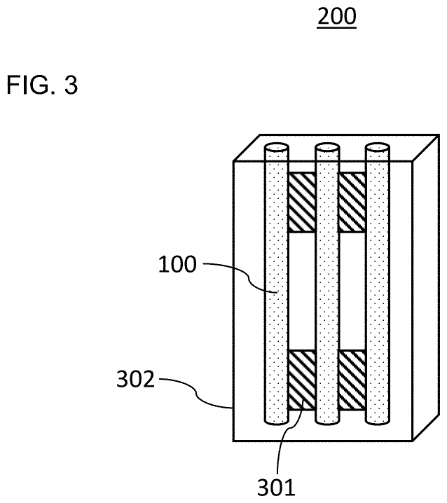

FIG. 3 shows a schematic depiction of another arrangement 200 according to the invention. The arrangement 200 comprises a packaging and a multitude of container precursors 100 of FIG. 1. The multitude of container precursors 100 is packaged in the packaging. Here, the packaging comprises multiple spacer elements 301 which are pieces of Styrofoam, formed to accommodate the container precursors 100, thereby spacing them from one another such that the walls of glass 101 do not touch, even under mechanical shocks and vibrations on a transport to a factory in which containers 500 are to be made from the container precursors 100. The packaging further comprises a case 302 which is a cardboard box. The multitude of container precursors 100 and the spacer elements 301 are disposed in the case 302.

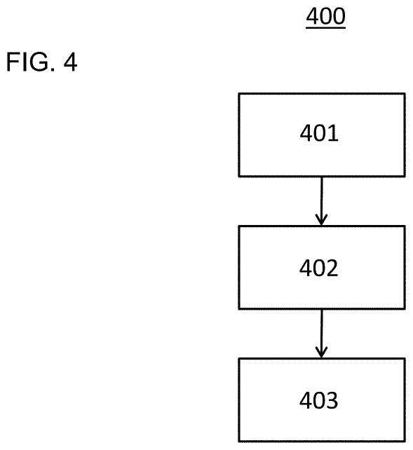

FIG. 4 shows a flow chart of a process 400 according to the invention for preparing a functionalised container precursor 100. The process 400 comprises a process step a) 401 in which a closed glass tube of the type “Fiolax clear” from Schott AG is provided. A process step b) 402 of superimposing a wall of glass 104 of the glass tube with a composition is conducted as described above for example 1. Accordingly, the composition comprises isopropanol as vehicle and a plurality of polysilsesquioxane-particles as first plurality of particles. Also the step c) 403 of decreasing a proportion of the isopropanol in the composition is conducted as described in the context of example 1. Thereby, the functionalised container precursor 100 is obtained, in which SiO₂-particles as further plurality of particles are joined to the wall of glass 101 across its full exterior surface. The functionalised container precursor 100 is a container precursor 100 as shown in FIG. 1.

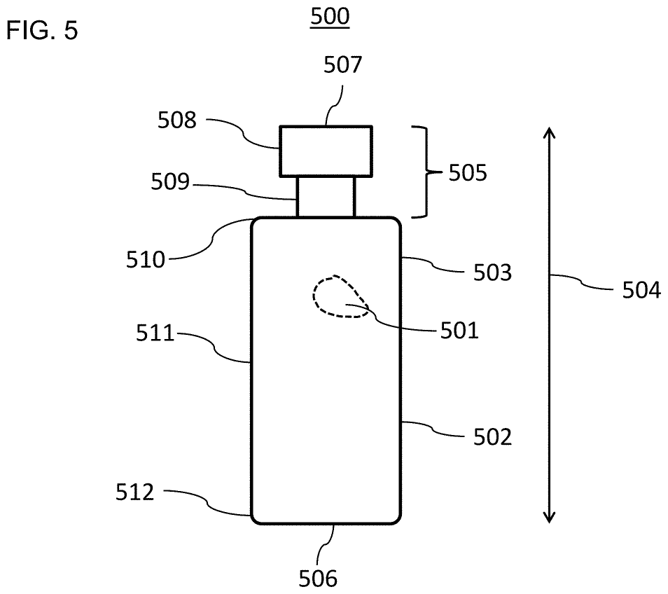

FIG. 5 shows a schematic depiction of a container 500 according to the invention. The container 500 comprises a wall of glass 502 which forms a hollow glass body 503 which partially encloses an interior volume 501 of the container 500. The hollow glass body 503 encloses the interior volume 501 only partially in that the container 500 comprises an opening 507 which allows for filling the container 500 with a pharmaceutical composition 701 (not shown). The hollow glass body 503 comprises in a direction of a length 504 of the hollow glass body 503: a first end region 505, a body region 511, and a further end region 506. Here, the length 504 is a height 504 of the hollow glass body 502. Further, the first end region 505 is a top region 505 of the container 500. The top region 505 consists of a flange 508 and a neck 509. The body region 511 follows the top region 505, from top to bottom, via a shoulder 510. The further end region 506 is a bottom region 506, here a standing base of the container 500, which follows the body region 511 via a heel 512. The body region 511 of the container 500 is a part of the tube of the container precursor 100 of FIG. 1. Accordingly, in the body region 511, on a side of the wall of glass 502 which faces away from the interior volume 501, the wall of glass 502 adjoins a plurality of particles 1201 which is a part of the plurality of SiO₂-particles mentioned in the context of FIG. 1. The top region 505, the shoulder 510, the heel 512 and the bottom region 506 have been obtained from parts of the tube of the container precursor 100 of FIG. 1 by a hot forming method, in the course if which these parts have been heated to temperatures above 1,200° C. Hence, the SiO₂-particles have been molten into the glass of the tube in that method. Thus, in the top region 505, the shoulder 510, the heel 512 and the bottom region 506, in each case on the side of the wall of glass 502 which faces away from the interior volume 501, the wall of glass 502 is not superimposed by any part of the plurality of particles 1201. Further, in the body region 511 a surface of the hollow glass body 503 which faces away from the interior volume 501 is characterised by a coefficient of dry sliding friction of 0.01. In the bottom region 506, a surface of the hollow glass body 503 which faces away from the interior volume 501 is characterised by a coefficient of static friction of 0.24. The container 500 of FIG. 5 is a vial which has been obtained in accordance with example 1 according to the invention as explained above.

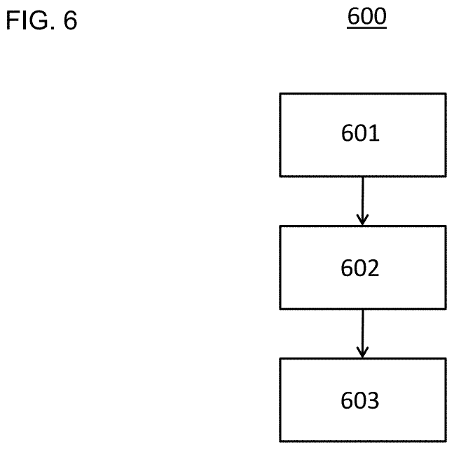

FIG. 6 shows a flow chart of a process 600 for preparing a functionalised container 500. In a process step A) 601, the container precursor 100 of FIG. 1 is provided. The end face parts 103 are cut off the tube. Then, in a process step B), the remaining tubular part of the container precursor 100 is at least partially heated above a transformation temperature T_{g} of the glass of the wall of glass 101. In a process step C), the functionalised container 500 is formed from a part of the heated tube by hot forming. Therein, the part of the tube is reshaped only partially. In consequence, the functionalised container 500 comprises a tubular part which has already been present in the container precursor 100. The functionalised container 500 is identical to the container 500 of FIG. 5. Accordingly, the preceding tubular part forms the body region 511 of the functionalised container 500.

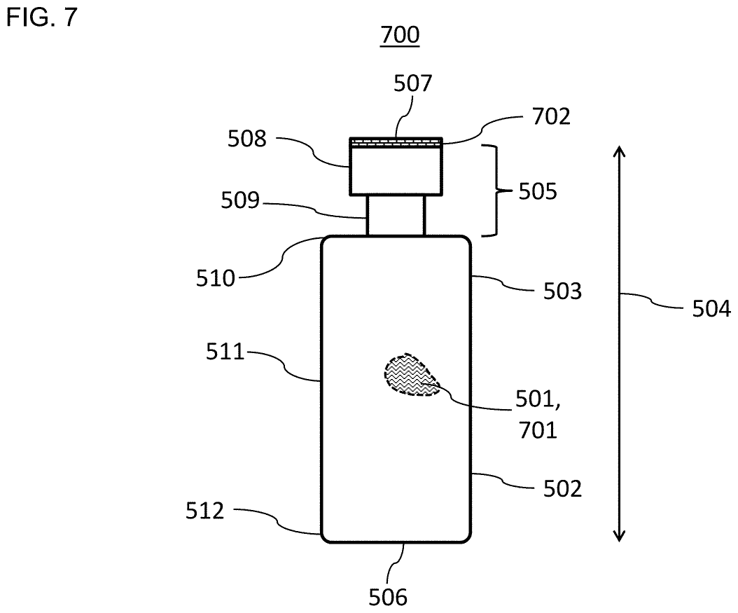

FIG. 7 shows a schematic depiction of a closed container 700 according to the invention. This closed container 700 is a vial which has been obtained by filling the container 500 of FIG. 5 with a pharmaceutical composition 701 and closing the opening 507 with a lid 702 via a crimping step. Here, the pharmaceutical composition 701 is a vaccine.

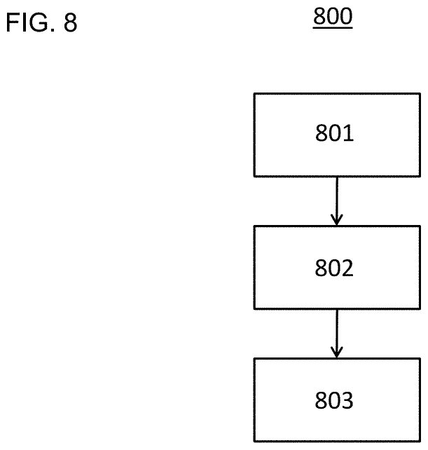

FIG. 8 shows a flow chart of a process 800 according to the invention for packaging a pharmaceutical composition 701. In a process step a. 801, the container 500 according to FIG. 5 is provided. In a process step b. 802, a pharmaceutical composition 701 is filled into the interior volume 501 of the container 500, and in a process step b. 803 the opening 507 of the container 500 is closed, thereby obtaining the closed container 700 of FIG. 7.

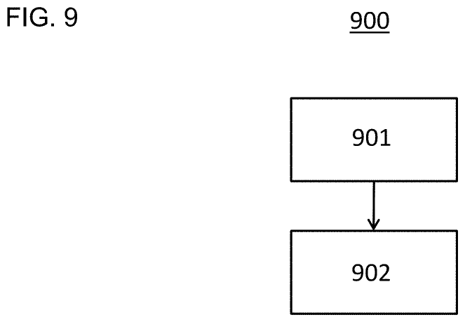

FIG. 9 shows a flow chart of a process 900 according to the invention for treating a patient. This process 900 comprises the process steps of: A] 901 providing the closed container 700 of FIG. 7, opening the closed container 700 by penetrating the lid 702 with a needle of a syringe, filling the syringe with the vaccine; and B] 902 administering the vaccine subcutaneously to a patient using the syringe.

FIG. 10 shows a diagram with results of measurements of the coefficient of dry sliding friction 1001 of the body regions 511 of vials of example 1 and comparative example 4. In the diagram, the bar 1002 shows measurement results for vials of example 1 after washing only, the bar 1003 shows measurement results for vials of example 1 after washing and subsequent depyrogenisation, the bar 1004 shows measurement results for vials of comparative example 4 after washing only, and the bar 1005 shows measurement results for vials of comparative example 4 after washing and subsequent depyrogenisation.

FIG. 11 shows results of measurements of the transmission coefficient of vials according to the examples 1 to 5 and the comparative example 4 over the wavelength in nm 1101. In the diagram, 1103 denotes the measurement results for the examples 1 to 5 and comparative example 4. All these results are so close to each other that the corresponding graphs appear as one in the diagram. The dip at 865 nm is a measurement artefact.

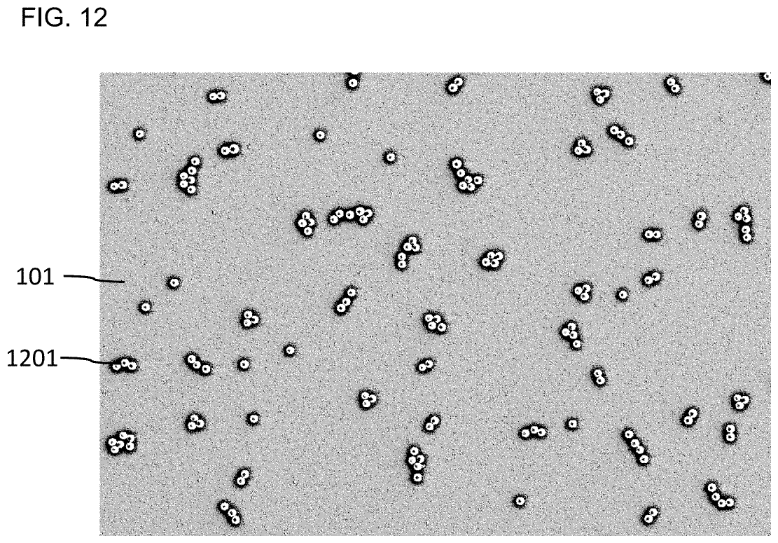

FIG. 12 shows a microscope image of the exterior surface of a functionalised container precursor 100 according to example 1. The image has been obtained using the following parameters: acceleration voltage (EHT)=5.99 kV, working distance (WD)=6.9 mm, magnification=1.00 k ×. The plurality of particles 1201 can clearly be seen on the wall of glass 101.

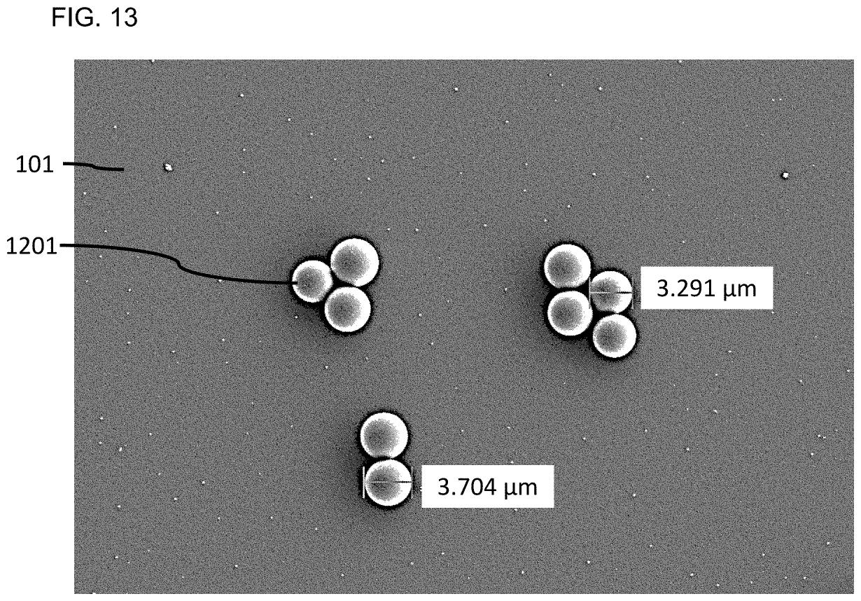

FIG. 13 shows a further microscope image of the exterior surface of the functionalised container precursor 100 according to example 1. This image has been obtained using the following parameters: acceleration voltage (EHT)=5.00 kV, working distance (WD)=7.0 mm, magnification=5.00 k ×. The plurality of particles 1201 can clearly be seen on the wall of glass 101. The diameters of two exemplary particles 1201 are shown in the figure to be at 3.292 μm and 3.704 μm, respectively. These diameters are smaller than the average diameter of the Tospearls 145A from which the particles 1201 have been obtained. This is because during the heat treatment described in the context of example 2 SiO₂-particles have been formed from the Tospearls 145A, wherein the particles have shrunk.

FIG. 14 shows a microscope image of the exterior surface of a vial according to example 2 prior to freeze drying. The plurality of particles 1201 can be seen on the wall of glass 502 of the vial.

FIG. 15 shows a microscope image of the exterior surface of the vial of FIG. 14 after freeze drying. The plurality of particles 1201 can still be seen on the wall of glass 502. Further, no defects or damages from the freeze drying are visible.

### LIST OF REFERENCE NUMERALS

100 container precursor/functionalised container precursor according to the invention
101 wall of glass of the container precursor
102 interior volume of the container precursor
103 end face part
104 hollow glass body of the container precursor
105 precursor exterior surface
200 arrangement according to the invention
201 first longitudinal end
202 first envelope
203 further longitudinal end
204 further envelope
301 spacer element
302 case
400 process of the invention for preparing a functionalised container precursor
401 process step a)
402 process step b)
402 process step c)
500 container/functionalised container according to the invention
501 interior volume of the container
502 wall of glass of the container
503 hollow glass body of the container
504 length/height of the container
505 first end region/top region
506 further end region/bottom region
507 opening
508 flange
509 neck
510 shoulder
511 body region
512 heel
600 process for preparing a functionalised container
601 process step A)
602 process step B)
603 process step C)
700 closed container according to the invention
701 pharmaceutical composition
702 lid
800 process according to the invention for packaging a pharmaceutical composition
801 process step a.
802 process step b.
803 process step c.
900 process according to the invention for treating a patient
901 process step A]
902 process step B]
1001 coefficient of dry sliding friction
1002 measurement results for example 1 after washing the vials
1003 measurement results for example 1 after depyrogenising the vials
1004 measurement results for comparative example 4 after washing the vials
1005 measurement results for comparative example 4 after depyrogenising the vials
1101 wavelength in nm
1102 transmission coefficient
1103 measurement results for examples 1 to 5 and comparative example 4
1201 particle of the plurality of particles

What is claimed is:

1. A container precursor comprising:
a wall of glass at least partially enclosing an interior volume; and
a plurality of particles at least partially superimposing a side of the wall of glass that faces away from the interior volume.

2. The container precursor of claim 1, wherein the plurality of particles superimposes at least 10% of the side of the wall of glass that faces away from the interior volume.

3. The container precursor of claim 1, wherein the plurality of particles superimposes 1 to 50% of the side of the wall of glass that faces away from the interior volume.

4. The container precursor of claim 1, wherein the side of the wall of glass that faces away from the interior volume has a coefficient of dry sliding friction of less than 0.25.

5. The container precursor of claim 1, wherein the plurality of particles is across between at least 10% and a full surface area of the side of the wall of glass that faces away from the interior volume.

6. The container precursor of claim 1, wherein the side of the wall of glass that faces away from the interior volume has a contact angle for wetting with water of 0 to 45°.

7. The container precursor of claim 1, wherein the wall of glass comprises a side that faces the interior volume that is not superimposed by any of the plurality of particles.

8. A container comprising:
a wall of glass that forms a hollow glass body at least partially enclosing an interior volume, wherein the hollow glass body comprises, in a direction of a length of the hollow glass body, a first end region, a body region, and a further end region;
a plurality of particles at least partially superimposing a side of the wall of glass that faces away from the interior volume in the body region,
wherein, in the first end region and/or in the further end region, the side of the wall of glass that faces away from the interior volume is not superimposed by any of the plurality of particles.

9. The container of claim 8, wherein the body region has a first coefficient of dry sliding friction at the side of the wall of glass that faces away from the interior volume, the first end region has a second coefficient of static friction, and the further end region has a third coefficient of static friction, the container further comprising a ratio of the first coefficient of dry sliding friction to the second coefficient of static friction and/or to the third coefficient of static friction in a range from 0.01 to 0.9; and
wherein the second and/or third coefficient of static friction is at least 0.15.

10. The container of claim 8, further comprising a closure closing the interior volume and a pharmaceutical composition in the interior volume.

11. The container of claim 8, wherein the particles of the plurality of particles are directly joined to the wall of glass via Van-der-Waals forces, but not via covalent bonds.

12. The container of claim 8, wherein the wall of glass comprises a side that faces the interior volume that is not superimposed by any of the plurality of particles.

13. The container of claim 8, wherein the plurality of particles comprise a particle size distribution selected from a group consisting of a D₅₀ in a range from 1 to 100 μm, a D₁₀ in a range from 0.1 to 50 μm, a D₉₀ in a range from 0.5 to 100 μm, a full width at half maximum (FWHM) which is less than 30%, and combinations thereof.

14. The container of claim 8, wherein the plurality of particles have a decomposition temperature of between more than 500° C. and 2,000° C.

15. The container of claim 14, wherein the decomposition temperature is more than 1,400° C.

16. The container of claim 8, wherein the plurality of particles comprise a material selected from a group consisting of a boron nitride, a molybdenum sulphide, a silicon nitride, an oxide, MoS₂, Si₃N₄, silicon oxide, titanium oxide, SiO₂, TiO₂, siloxane, a silane, organo-silane, latex, silicone resin, hybridpolymer silane, a hybridpolymer siloxane, polyorganosiloxane, polyalkylsiloxane, polysilsesquioxane, inorganic silane,

17. The container of claim 8, wherein the particles of the plurality of particles are not embedded in any material.

18. The container of claim 8, wherein the plurality of particles have an aspect ratio in a range from 0.5 to 1.5.

19. The container of claim 8, wherein the wall of glass has a transmission of light of a wavelength in a range from 400 nm to 2300 nm of more than 0.7.

20. An arrangement comprising:
a packaging; and
a plurality of containers of claim 8 packaged in the packaging.

21. A process for preparing a functionalised container precursor, comprising:
providing a wall of glass that at least partially encloses an interior volume;
superimposing at least a part of the wall of glass on a side of the wall of glass that faces away from the interior volume with a composition, the composition comprising a first plurality of particles and a vehicle; and
decreasing a proportion of the vehicle in the composition, thereby leaving the first plurality of particles and/or particles obtained from the first plurality of particles superimposed on the wall of glass.
